(19) United States
(12) Patent Application Publication
(10) Pub. No.: US 2025/0349462 A1
(43) Pub. Date: Nov. 13, 2025

(54) TRANSFORMER WITH LEAKAGE INDUCTANCE

(71) Applicants: Ayan MALLIK, Gilbert, AZ (US); Saikat DEY, Tempe, AZ (US)

(72) Inventors: Ayan MALLIK, Gilbert, AZ (US); Saikat DEY, Tempe, AZ (US)

(73) Assignee: Arizona Board of Regents on behalf of Arizona State University, Scottsdale, AZ (US)

(21) Appl. No.: 19/201,791

(22) Filed: May 7, 2025

Related U.S. Application Data
(60) Provisional application No. 63/644,502, filed on May 8, 2024.

(51) Int. Cl. H01F 30/06; H01F 27/26; H01F 27/30

(52) U.S. Cl. CPC H01F 30/06; H01F 27/266; H01F 27/306

(57) ABSTRACT

A transformer with leakage inductance. In some embodiments, a system includes: a transformer including: a core, including: a central limb, a first outer limb, and a second outer limb; a first winding; and a second winding, wherein a first turn of the first winding encircles the central limb and the first outer limb.

### CROSS-REFERENCE TO RELATED APPLICATION(S)

The present application claims priority to and the benefit of U.S. Provisional Application No. 63/644,502, filed May 8, 2024, entitled “TRANSFORMER WITH LEAKAGE INDUCTANCE”, the entire content of which is incorporated herein by reference.

### FIELD

One or more aspects of embodiments according to the present disclosure relate to power conversion, and more particularly to a transformer with leakage inductance.

### BACKGROUND

In applications such as electric-vehicle power trains, space station power supplies, microgrids, and other applications in which multiple energy resources or loads are connected together to efficiently support the power system, the use of a single stage multi-port power electronic converter with omni-directional power flow capability may be advantageous.

It is with respect to this general technical environment that aspects of the present disclosure are related.

### SUMMARY

According to an embodiment of the present disclosure, there is provided a system, including: a transformer including: a core, including: a central limb, a first outer limb, and a second outer limb; a first winding; and a second winding, wherein a first turn of the first winding encircles the central limb and the first outer limb.

In some embodiments, a first turn of the second winding encircles the central limb and the second outer limb.

In some embodiments, a second turn of the first winding encircles the central limb and the first outer limb.

In some embodiments, a second turn of the second winding encircles the central limb and the second outer limb.

In some embodiments, the transformer further includes a third winding.

In some embodiments, a turn of the third winding encircles the central limb.

In some embodiments, every turn of the third winding encircles the central limb.

In some embodiments, a turn of the third winding includes two conductors connected in parallel.

In some embodiments, the transformer includes a first printed circuit board, including a turn of the second winding.

In some embodiments: the transformer includes a second printed circuit board; the first printed circuit board includes a turn of the first winding; and the second printed circuit board includes a turn of the first winding.

In some embodiments, the second printed circuit board includes a turn of the third winding.

In some embodiments, the second printed circuit board is separated from the first printed circuit board by a gap.

In some embodiments: a first layer of the first printed circuit board includes a first turn of the first winding; a second layer of the first printed circuit board includes a second turn of the first winding; and a third layer of the first printed circuit board, between the first layer and the second layer, includes a turn of the second winding.

In some embodiments, the core is an E-E core.

In some embodiments, the first turn of the first winding includes copper wire.

In some embodiments, the first turn of the first winding includes copper Litz wire.

According to an embodiment of the present disclosure, there is provided a system, including: a transformer including: a core, including: a first outer limb, and a second outer limb; and a printed circuit board, including: a first winding, a second winding, and a third winding, wherein: a first turn of the second winding encircles the first outer limb in a first layer of the printed circuit board, a second turn of the second winding encircles the first outer limb in the first layer, and only one turn of the second winding encircles the second outer limb in a second layer of the printed circuit board.

In some embodiments, only one turn of the second winding encircles the first outer limb in a third layer of the printed circuit board.

In some embodiments, the second layer does not include a turn of the second winding encircling the first outer limb.

In some embodiments, the first winding includes a first number of turns encircling the first outer limb and a second number of turns, different from the first number of turns, encircling the second outer limb.

### BRIEF DESCRIPTION OF THE DRAWINGS

These and other features and advantages of the present disclosure will be appreciated and understood with reference to the specification, claims, and appended drawings wherein:

FIG. 1 is a schematic diagram of a triple-active-bridge (TAB) converter, according to an embodiment of the present disclosure;

FIG. 2 shows three graphs of waveforms, according to an embodiment of the present disclosure;

FIG. 3A and FIG. 3B show simplified Y and A-equivalent circuits, according to an embodiment of the present disclosure;

FIG. 3C is a table of design parameters, according to an embodiment of the present disclosure;

FIG. 4 is a schematic drawing of a transformer design, according to an embodiment of the present disclosure;

FIG. 5A is a schematic drawing of an equivalent magnetic circuit model, according to an embodiment of the present disclosure;

FIG. 5B is a schematic drawing of a transformer design, according to an embodiment of the present disclosure;

FIG. 6 is a graph of waveforms, according to an embodiment of the present disclosure;

FIGS. 7A and 7B are graphs of leakage inductance as a function of gap, according to an embodiment of the present disclosure;

FIG. 8A is a graph of winding resistance as a function of frequency, according to an embodiment of the present disclosure;

FIG. 8B is a table of winding losses, according to an embodiment of the present disclosure;

FIG. 9 is a schematic drawing of a transformer design, according to an embodiment of the present disclosure;

FIG. 10 is a schematic drawing of an equivalent magnetic circuit model, according to an embodiment of the present disclosure;

FIG. 11 is a graph of a magnetic loss-based design optimization result, according to an embodiment of the present disclosure;

FIG. 12 is a flow chart, according to an embodiment of the present disclosure;

FIG. 13 is a graph of leakage inductance as a function of gap, according to an embodiment of the present disclosure;

FIG. 14 is a schematic drawing of a transformer design, according to an embodiment of the present disclosure;

FIG. 15 is a schematic drawing of a magnetic circuit model, according to an embodiment of the present disclosure;

FIG. 16A is a graph of leakage inductance as a function of air gap, according to an embodiment of the present disclosure;

FIG. 16B is a graph of equivalent turns ratio as a function of air gap, according to an embodiment of the present disclosure;

FIG. 17A is a graph of leakage inductance as a function of air gap, according to an embodiment of the present disclosure;

FIG. 17B is a graph of equivalent turns ratio as a function of air gap, according to an embodiment of the present disclosure;

FIG. 18 is a graph of a magnetic loss-based design optimization result, according to an embodiment of the present disclosure;

FIG. 19 is a graph of the variation of winding resistances as a function of the current excitation frequency, according to an embodiment of the present disclosure; and

FIG. 20 is a flow chart, according to an embodiment of the present disclosure.

### DETAILED DESCRIPTION

The detailed description set forth below in connection with the appended drawings is intended as a description of exemplary embodiments of a transformer with leakage inductance provided in accordance with the present disclosure and is not intended to represent the only forms in which the present disclosure may be constructed or utilized. The description sets forth the features of the present disclosure in connection with the illustrated embodiments. It is to be understood, however, that the same or equivalent functions and structures may be accomplished by different embodiments that are also intended to be encompassed within the scope of the disclosure. As denoted elsewhere herein, like element numbers are intended to indicate like elements or features.

In a world of growing environment-friendly energy consumption and increasing efficiency needs, research pertaining to distributed versatile energy management systems is getting special attention from the research community. As mentioned above, in cutting-edge applications such as electric-vehicle power trains, space station power supplies, microgrids, and other applications in which multiple energy resources or loads are connected together to efficiently support the power system, the use of a single stage multi-port power electronic converter with omni-directional power flow capability may be advantageous. Such a converter may make it possible to reduce the size, cost, volume, and control complexity of the power conversion system, because of lower component count and the simplicity of centralized control. One such circuit topology is a triple-active bridge (TAB), where three full bridges form three ports for the converter that are magnetically coupled together through a three-winding transformer.

Since the TAB converter is usually targeted to achieve least system losses as well as lowest volume, the required line inductances of a TAB may be integrated in a high frequency planar transformer in the form of a leakage inductance for each winding. Moreover, the required value of the TAB leakage inductances depends on the desired power transfer as well as the targeted zero-voltage-switching (ZVS) range of the converter. Under such circumstances, it may be challenging to realize the required values of the leakage inductances in a conventional three-winding planar transformer with PCB integrated windings.

This disclosure presents three possible winding arrangements for a three-winding transformer employed in a TAB converter. For validation purposes of the analytical models described in this disclosure, three of the proposed transformer designs have been fabricated and tested with a 1.2 KW rated triple-active-bridge converter prototype with input and output nominal voltage levels of 160 V and 120 V/28 V, respectively.

Section II of this disclosure explains the requirements for the TAB transformer design under the desired application criteria and sets the design targets. Section III describes a detailed comparative study of three different transformer configurations for the TAB converter that realize substantial leakage and magnetizing inductances while maintaining low winding and core losses and high power density. Along with a symmetric three-winding transformer design (Case 1), two asymmetric winding arrangements are presented in this section that generate differential magnetic flux in the core, responsible for realizing substantial leakage inductances while maintaining sufficient magnetizing inductance for TAB operation. During the Case 1 design, the air-coupled leakage inductances as well as winding resistances are accurately formulated considering a non-linear distribution of MMF across the core window area due to the frequency dependent ac eddy current effect and the low frequency radial effect in planar winding structures. Furthermore, a precise formulation of the winding and core losses of different transformer structures is performed while considering higher order winding current and voltage harmonics along with the fundamental ac waveshape for better computation accuracy.

A hybrid central limb and side limb wound uneven and interleaved winding configuration (Case 3) enables decoupled and precise control over leakage and magnetizing inductances in a three-winding TAB and also performs the best, of the three different transformer configurations, in terms of total converter losses. The design guidelines for magnetic loss optimized leakage-integrated three winding transformer design with asymmetric winding distributions are also presented, at the end of Section III.

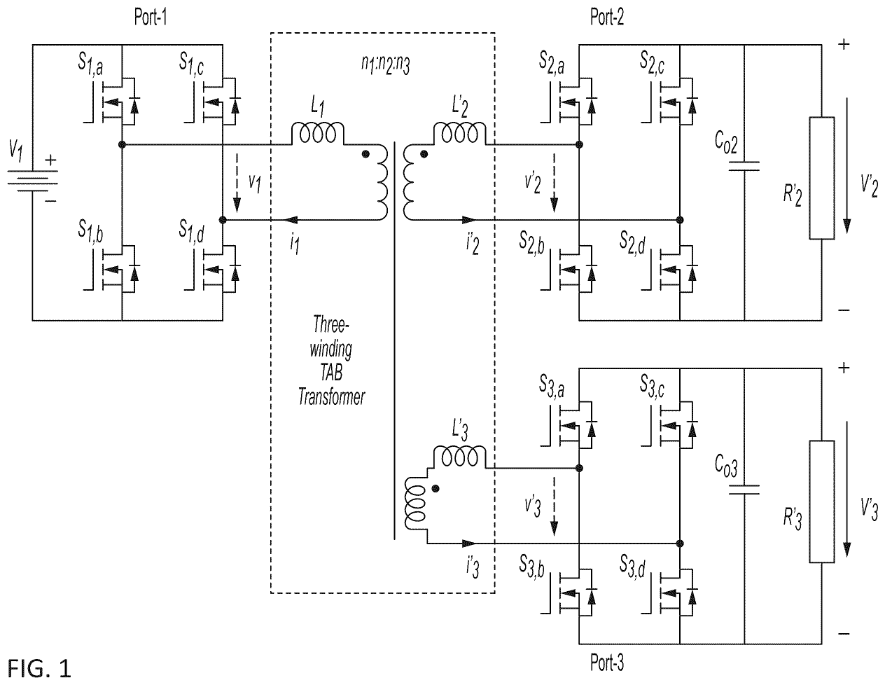

The circuit topology of a triple-active-bridge (TAB) converter, as shown in FIG. 1, includes (e.g., consists of) a three-winding transformer that is directly connected to three independent full bridges, having distinct terminal dc link voltages V′ₖ, where k∈{1, 2, 3}. In the notation used herein,

$${V}_{1}^{′} = {V}_{1} ( \frac{{n}_{1}}{{n}_{1}} ) = {V}_{1} .$$

Thus, for port-1, the dc link voltage can be written as V₁. V′₂, V′₃, and V′ₖ are the actual dc bus voltages of port-2, port-3 and any arbitrary port-k. When referred to the primary side or port-1 in an equivalent circuit model, these become V₂, V₃, and Vₖ, and

$${V}_{k} = {V}_{k}^{′} ( \frac{{n}_{1}}{{n}_{k}} ) .$$

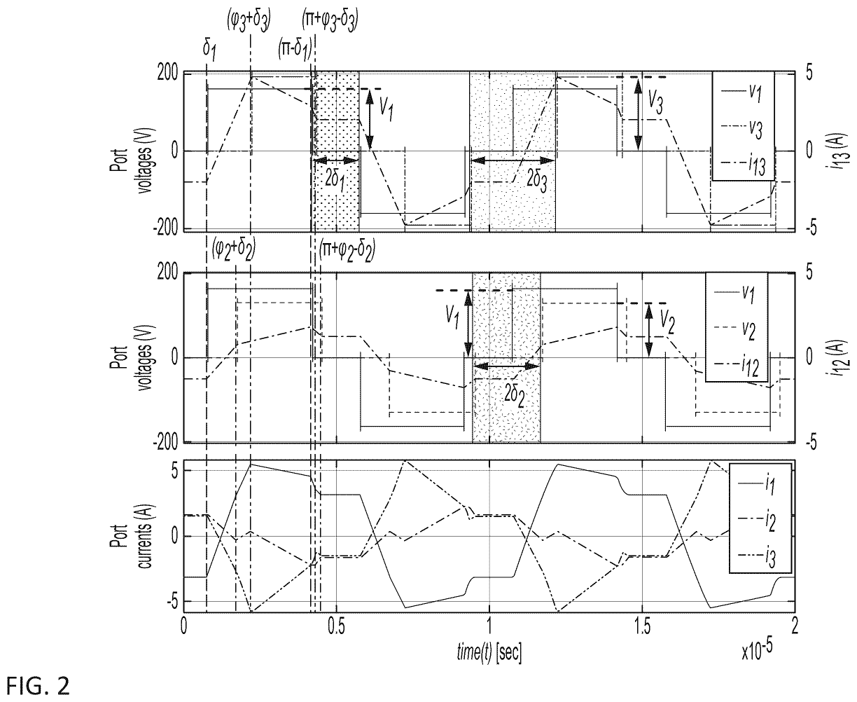

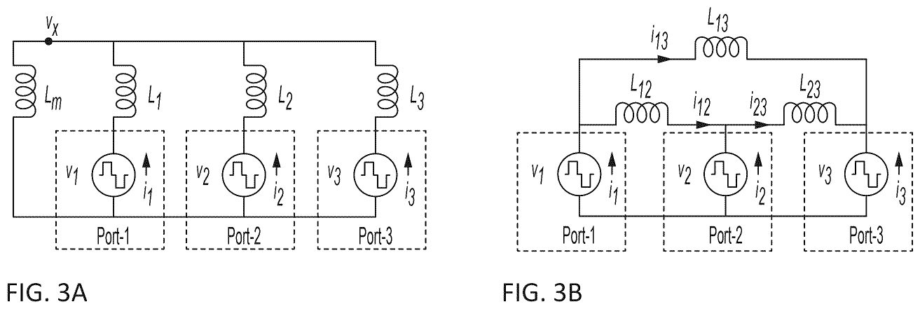

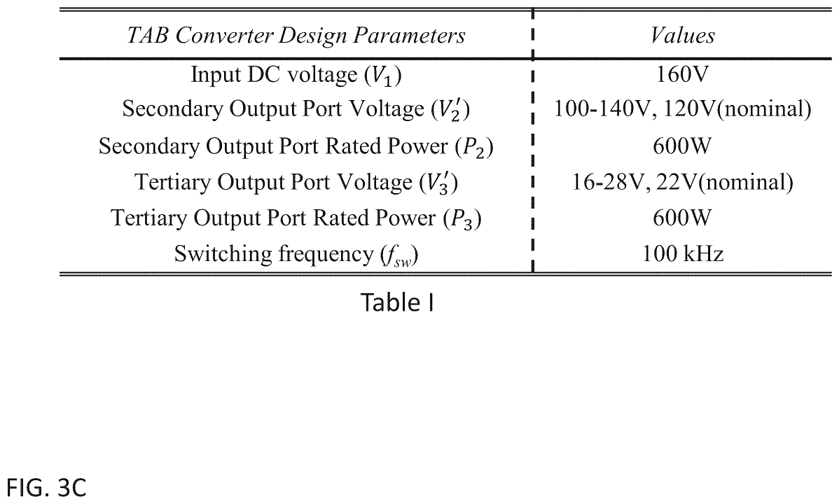

The full bridges are utilized to generate quasi-square shaped voltage waveforms, v′ₖ (shown in FIG. 2), at the transformer terminals with arbitrary duty cycles (δₖ) and mutual phase shifts (φₖ) in order to facilitate a desired power flow among the three converter ports. The complete TAB converter may be depicted as simplified Y and Δ-equivalent circuits, as presented in FIG. 3A and FIG. 3B, where the circuit elements are referred to the primary side (port-1, k=1) of the transformer. Further, the inter-port line inductances in the Δ-network are related to the TAB transformer's individual winding leakage inductances as:

$${L}_{i j} = {( \frac{1}{{L}_{m}} + {\sum }_{k \neq i , j}^{3} \frac{1}{{L}_{k}} )}^{- 1} ,$$

where

$${L}_{k} = {{L}_{k}^{′} ( \frac{{n}_{1}}{{n}_{k}} )}^{2} ,$$

n₁:n₂:n₃ is the transformer's turns ratio, and Lₘ is the magnetizing inductance of the transformer. Aspects of the analysis of the converter are disclosed in (i) S. Dey and A. Mallik, “Multivariable-Modulation-Based Conduction Loss Minimization in a Triple-Active-Bridge Converter,” in IEEE Transactions on Power Electronics, vol. 37, no. 6, pp. 6599-6612 Jun. 2022, doi: 10.1109/TPEL.2022.3141334, (“Article 1”) which is incorporated herein by reference, and in (ii) S. Dey, A. Mallik and Δ. Akturk, “Investigation of ZVS criteria and Optimization of Switching Loss in a Triple Active Bridge Converter using Penta-Phase-Shift Modulation,” in IEEE Journal of Emerging and Selected Topics in Power Electronics, 2022, doi: 10.1109/JESTPE.2022.3191987, (“Article 2”) which is incorporated herein by reference.

The TAB converter under study is targeted to meet design requirements for the dc input and output terminals, which are provided in Table I (FIG. 3C). In some embodiments, to achieve an efficient power flow among the TAB ports, the dc port voltage ratio corresponds to the transformer turns ratio, where the ratios between the RMS port currents and the average output currents are close to unity and thus optimal. Furthermore, as the port voltage ratios deviate from their respective winding turns ratios, the transformer winding current peak as well as RMS currents increase substantially, thus increasing the losses in the switching network. Therefore, a requirement for the TAB transformer may be to keep the turns ratio close to V₁:V₂:V₃, that is, 160:22:16 per Table I, during nominal converter operation.

Moreover, the total power transferred from port-i to port-j (i, j∈{1, 2, 3}) in a TAB converter may be obtained using Equation 1 while considering up to m^{th} odd Fourier series harmonics in modeling vₖ and iₖ:

$${P}_{i j} = \frac{4}{{π}^{3} {f}_{s w}} \cdot {\sum }_{k = 1}^{2 m + 1} \frac{1}{{k}^{3}} [ \frac{{V}_{i} {V}_{j}}{{L}_{i j}} {d}_{k i} {d}_{k j} sin \{ k ( {φ}_{j} - {φ}_{i} ) \} ] \qquad ( 1 )$$

It may be inferred from Equation 1 that for a particular Vₖ and f_{sw} operation, the maximum power transfer between two TAB ports is limited by the inter-port line inductance (Lᵢⱼ) that may be formed using the integrated leakage inductances of the TAB transformer. This condition sets an upper bound on the leakage inductance of the three-winding transformer. According to the design requirement, to attain a full load power of 1.2 KW under any output port voltage gain condition (where the voltage gain

$${m}_{k} = \frac{{V}_{k}}{{V}_{1}} = 16 ( \frac{7}{1} ) / 160$$

and 0.7≤mₖ≤1.25, according to the design specification of Table I), the leakage inductance per winding referred to the primary may be limited to 17 μH.

Although maintaining a lower value of the TAB leakage inductance aids in realizing more power transfer capability, the use of a lower leakage inductance may also have the effect that any change in the phase-shift control variables ((k) has a reduced effect on the port power transfer and the resolution of ok drops significantly due to the decrease in the value of

$$\frac{{Δφ}_{k}}{Δ {P}_{i j}} .$$

This makes the control system less robust and more prone to transient disturbances. Additionally, in a TAB converter, the minimum required leakage inductance to achieve zero-voltage-switching (ZVS) at all the full-bridge switches increases as the output load decreases for any particular mₖ. Attaining ZVS at light load may demand much higher leakage than at heavy load condition. Also, as mx deviates from unity, the Lk requirement for ZVS increases. Thus, a substantial amount of per winding leakage inductance may be present in the TAB transformer in order to achieve ZVS for a wide range of converter operational voltage and load. Therefore, while the maximum power transfer criterion imposes an upper bound on Lₖ, the desired ZVS criterion sets the lower bound on Lₖ.

### III. Geometrical Configurations and Magnetic Modeling of Three-Winding Planar Transformer Candidates

A challenge in the transformer design for the TAB topology lies in the requirement for large series line inductance values Lx, as for the sake of achieving high power-density, these series inductances should be integrated in the three-winding transformer by controlling the leakage inductance values of the different windings. This may be challenging, however, due to strong coupling between the windings in a planar PCB transformer. In the study of optimal winding structures for three-winding planar transformers it may be important, in a fully optimized design to further consider the winding and core losses (so as to achieve best possible component power efficiency) and the leakage inductance (which may be substantial to extend the ZVS range of the converter). Three distinct winding structures are modeled and compared below for these pertinent characteristics with the objective of determining the ZVS range considering the achievable integrated leakage inductance range in each.

### A. Case 1: Central Limb Wound Transformer Design

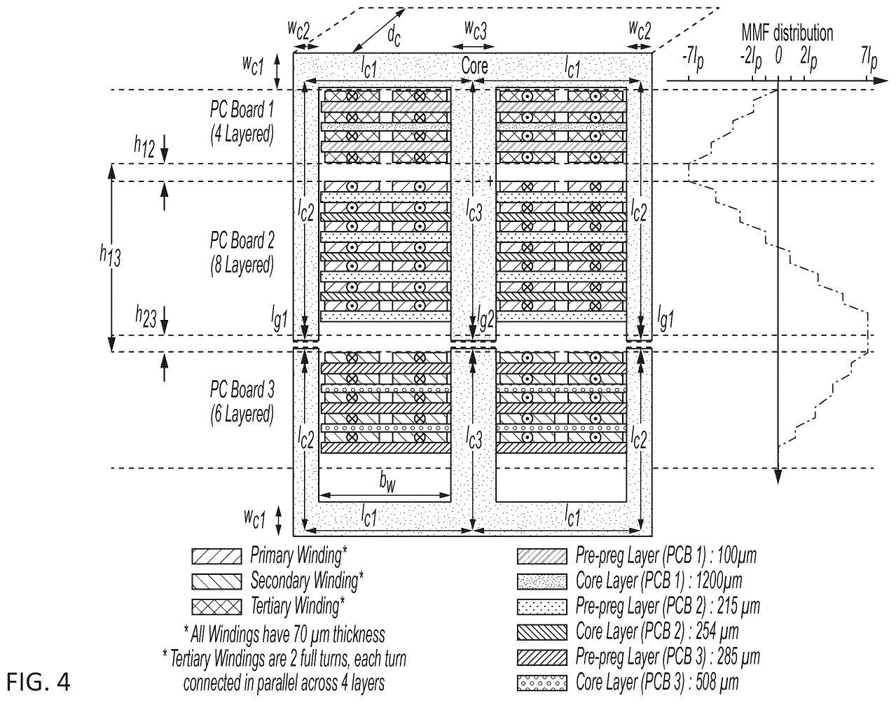

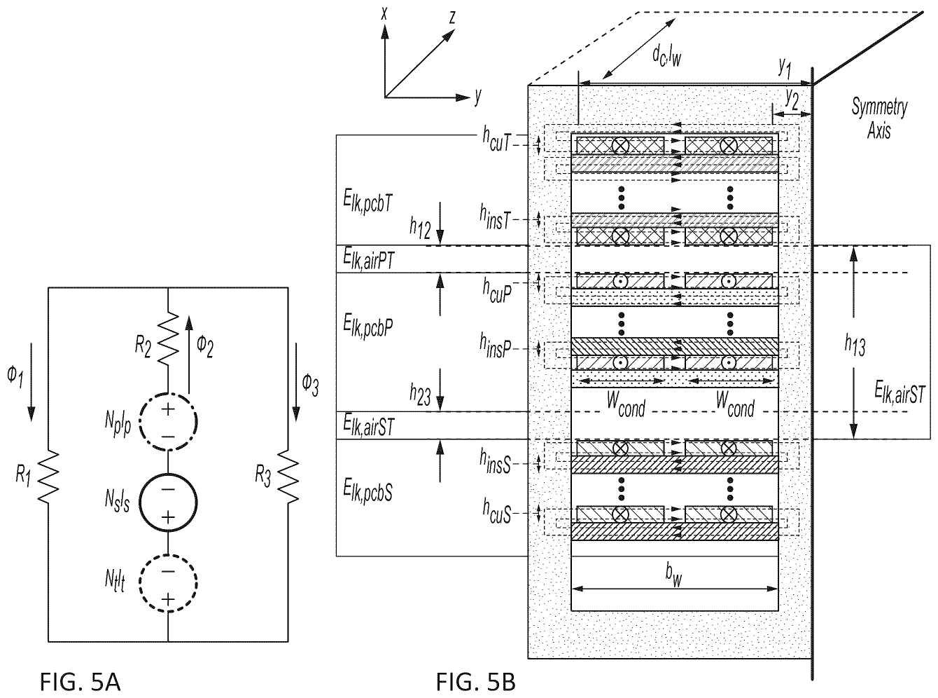

As seen in FIG. 4, the first case (“Case 1”) consists of a design in which all planar windings are routed on the center limb of the transformer with turns ratio n₁:n₂:n₃₌14:10:2. Considering the power level of the requirements, an EE shaped transformer core FR46410EC′ with R type ferrite material from Mag-Inc. may be employed for the Case 1 design. A similar size and material of the core is also selected for the other TAB transformer designs disclosed herein. Limiting the temperature rise of the current carrying conductors to 40° C., 2 oz Cu traces are placed on each of the PCB layers, filling the whole window width (b_{w}) by two series turns. Due to a high current requirement in the tertiary winding, four parallel winding layers are used, in a parallel configuration that offers current sharing. Here, the winding structure is intentionally kept non-interleaved so as to achieve the maximum effect of leakage energy, which is uniformly stored in the air gap between the separate winding PCBs. FIG. 4 is a cross-sectional view, not drawn to scale; it is stretched in the vertical direction so that the individual PCB layers are discernible. FIGS. 5B, 9, and 14 are also cross-sectional views stretched in the vertical direction.

In this structure, the entire magnetizing flux circulates through the transformer core according to the equivalent magnetic circuit model, depicted in FIG. 5A. In the figure, Nₚ, Nₛ and Nₜ are the number of primary, secondary, and tertiary turns, each carrying RMS currents of Iₚ, Iₛ and Iₜ, respectively. As a result, the core reluctance only influences the transformer magnetizing inductance as found in Equation 3 assuming equal air gap distances in the outer limbs, such that ϕ₁=ϕ₃ and R₁=R₃.

$${Φ}_{2} = \frac{{N}_{p} {I}_{p} - {N}_{s} {I}_{s} - {N}_{t} {I}_{t}}{{R}_{2} + \frac{{R}_{1}}{2}} \qquad ( 2 )$$

$${L}_{m} = \frac{{N}_{p} {φ}_{2} {\vert}_{{I}_{s} = {I}_{f} = 0}}{{I}_{p}} = \frac{{N}_{p}^{2}}{{R}_{2} + \frac{{R}_{1}}{2}} \qquad ( 3 )$$

where R₂, R₁ and R₃ denote the reluctances of the central limb and two outer limbs of the magnetic core, respectively, along with their corresponding air gap reluctances. The reluctance of any particular segment of the core may be measured as

$${R}_{{l}_{seg}} = \frac{{l}_{seg}}{{μ}_{o} {μ}_{r} {A}_{seg}} ,$$

where l_{seg} and A_{seg} are the length and cross-sectional area of the particular segment, and where μₒ and μᵣ are the permeability of the air and relative permeability of the core material. Thus, from the core geometry, shown in FIG. 4, the reluctances may be interpreted as

$${R}_{1} = 2 {R}_{{l}_{c 1}} + 2 {R}_{{l}_{c 2}} + {R}_{{l}_{g 1}} and {R}_{2} = 2 {R}_{l c 3} + {R}_{l g 2} ,$$

where the air gap reluctances are

$${R}_{{l}_{g 1}} = \frac{{l}_{{g}_{1}}}{{μ}_{o} {w}_{c 2} {d}_{c}} and {R}_{{l}_{g 2}} = \frac{{l}_{{g}_{2}}}{{μ}_{o} {w}_{c 3} {d}_{c}} .$$

Since the TAB converter demands high magnetizing inductance so that it does not take part in the power flow, R₁ and R₂ are kept minimal in Equation 3 by keeping near zero air gap between the magnetic cores.

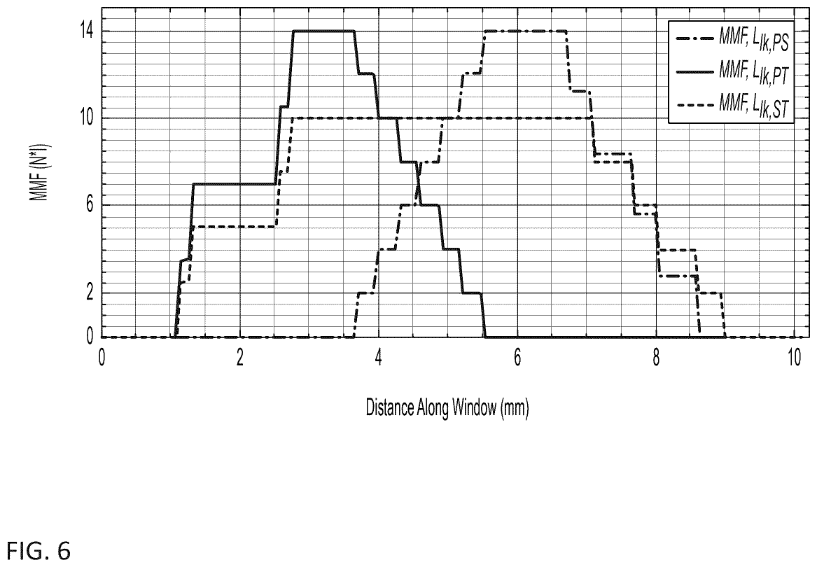

In order to synthesize the maximum leakage inductances from such a transformer design, the distance between the separate windings or the distance between the PCBs may be made maximum so that more leakage energy may be stored in the window air gaps. Due to the flat shape of the planar transformer, which reduces the parasitic effects from the edges, it may be assumed the leakage flux is horizontal to the winding layers and confined in the window area with a uniform distribution, as shown in FIG. 5B. A trapezoidal shape of magnetic flux intensity is formed in the window area when the current is evenly distributed among two of the primary, secondary and tertiary windings while keeping the third winding open circuited (FIG. 6). Three separate sequential short-circuit tests (primary-secondary, primary-tertiary, and secondary-tertiary) with results referred to the primary winding may be used to determine the individual Y-model leakage inductances of a TAB transformer. FIG. 6 demonstrates the MMF distribution established in the window core area in each short-circuit test, providing intuition regarding the significant impact of MMF on magnetic field strength in the Case 1 planar transformer and subsequently the eventual linking inductances, which play a role in power transfer and in achieving ZVS for high-density TAB converter applications. The stored magnetic energy in the window area due to excitation of i and j windings (i, j∈primary, secondary, tertiary) is

$${E}_{lk , ij} = \frac{1}{2} {L}_{lk , ij} {i}^{2} = \frac{{μ}_{0}}{2} \int {H}^{2} ( x ) d V \qquad ( 4 )$$

where V denotes the volume of each window fraction and L_{lk,ij} is the total leakage inductance between i and j windings:

$${L}_{lk , ij} = {L}_{i} + {( \frac{{N}_{i}}{{N}_{j}} )}^{2} {L}_{j} \qquad ( 5 )$$

To accurately quantify the leakage inductances, three sometimes overlooked effects may be taken into account. First, some analyses assume a linear frequency independent distribution of the H (x) along the winding thickness. However, with the high-frequency eddy current effect, this distribution becomes a nonlinear function of frequency, and this distribution may be modeled for improved accuracy. Second, the derived analytical formula of leakage inductance takes into consideration the dielectric layer thickness between the PCB conduction layers, which if neglected may lead to values of the calculated inductances that are in error by 30% or more. Third, the low height-width aspect ratio of the planar windings may result in a non-uniform current density distribution, caused by the low-frequency radial effect. This current density distribution may be modeled for improved accuracy. Such an effect may also be considered while performing the leakage calculation for Case 1.

Calculation of the leakage inductance starts from finding the leakage energy built up per PCB winding. Within the PCB planar windings of thickness hₒᵤ in each layer, the leakage energy solution is derived by solving Maxwell's equations in Cartesian coordinates for a magnetoquasistatic system in a linear homogeneous isotropic medium. The solution results in a second-order ordinary differential equation to which the general solution of the Helmholtz equation is applied, considering boundary conditions invoked by the developed magnetic field as in Equation 6. Due to the radial effect, H₀ in Equation 6 is derived as in Equation 7 from the model for the tendency of the winding current to flow in the inner path along the conductor that is adjacent to the central limb of the core. Leakage energy in a conductive winding may be calculated using Equation 8.

$$H ( x , y ) = {H}_{0} ( x , y ) \frac{n sinh ( γ x ) + ( n - 1 ) sinh ( γ h - γ x )}{sinh ( γ h )} \qquad ( 6 )$$

$${H}_{0} = \frac{{I}_{rm s}}{y ln ( \frac{{y}_{2}}{{y}_{1}} )} \qquad ( 7 )$$

$${E}_{w} = \frac{{μ}_{o} {l}_{w}}{2} {\int }_{0}^{{h}_{c u}} {\int }_{{y}_{1}}^{{y}_{2}} {H ( x , y )}^{2} d x d y \qquad ( 8 )$$

Total leakage energy from all conductive planar winding layers is then found as the summation of each solution. As a printed circuit board (PCB) will have a constant winding thickness, h_{cu}, in each layer, as per FIG. 6, the total leakage energy for Nₓ total turns of X-winding is found by Equation 9 for primary (P), secondary(S), and tertiary (T) planar windings.

$${E}_{w , X} = {\sum }_{k = 1}^{{n}_{X}} {E}_{k} = \frac{{μ}_{o} {l}_{w , X} {I}_{rm s , X}^{2} {N}_{X} ( {k}_{1} ( 2 {N}_{X}^{2} + 1 ) + 4 {k}_{2} ( {N}_{X}^{2} - 1 )}{24 ln ( \frac{{y}_{2}}{{y}_{1}} ) γ {sinh}^{2} ( γ {h}_{cu , X} )} , X ∈ \{ P , S , T \} \qquad ( 9 )$$

where

$${k}_{1} = sinh ( 2 γ {h}_{cu , P} ) - 2 γ {h}_{c u , P} ; {k}_{2} = γ {h}_{p} cosh ( γ {h}_{cu , P} ) - sinh ( γ {h}_{c u , P} ) ; γ = \frac{1 + j}{{δ}_{w}} ; {I}_{rm s , X}$$

is the RMS current in winding X, and I_{w,x} the total winding mean turn length (MTL) accounting for all turns across each conducting PCB layer. The y₁ and y₂ parameters are the distances from the core center to the outer and inner edges of the winding for modeling the low-frequency radial effect on current density distribution, and y is the complex propagation constant dependent upon the conductor skin depth Ow, which models the eddy current effect on current density distribution, introducing a high frequency-dependent term for the magnetic field strength solution.

For calculating the accrued energy in the insulative dielectric layers, only the radial effect due to current density distribution in the adjacent winding layer is considered as there is no current carrying conductor inside the volume. Additionally, due to the prepreg and core layers having different thicknesses throughout the PCB stack-up, two separate summation series may be evaluated for precision in the calculated energy.

$${E}_{prp , X} = \frac{{μ}_{o} {h}_{p r p} , X}{2} {\sum }_{k = 1}^{{n}_{prp , X}} {\int }_{{y}_{1}}^{{y}_{2}} {( \frac{{n}_{layer} {I}_{rm s , X}}{y ln ( \frac{{y}_{2}}{{y}_{1}} )} )}^{2} {l}_{w , X} dy \qquad ( 10 )$$

$${E}_{core , X} = \frac{{μ}_{o} {h}_{c ore , X}}{2} {\sum }_{k = 1}^{{n}_{c ore , X}} {\int }_{{y}_{1}}^{{y}_{2}} {( \frac{{I}_{rm s , X}}{y ln ( \frac{{y}_{2}}{{y}_{1}} )} )}^{2} {l}_{w , X} d y \qquad ( 11 )$$

h_{prp,x} and h_{core,x} are the thicknesses of the PCB prepreg and core dielectric layers, while I_{w,x} is the total mean turn length of the winding in the adjacent conducting layer and n_{layer} is the total sum of winding turns in the present layer and all preceding layers. The leakage energy in the air gaps between the PCBs is then found neglecting both effects by considering the total MMF (IᵣₘₛN_{PCB}) developed at the PCB boundary,

$${E}_{air , X} = \frac{{μ}_{0} {b}_{w} {d}_{c}}{2} {( \frac{{I}_{r m s , X} {N}_{X}}{{b}_{w}} )}^{2} , X ∈ \{ P , S , T \} \qquad ( 12 )$$

for which b_{w} is the window width and dc the core depth. With the MMF distribution of FIG. 6 in mind, Equations 13-15 provide the three leakage inductances from transformer short-circuit tests with respect to the primary winding:

$${L}_{lk , PS} = \frac{{E}_{w , P} + {E}_{air , PS}}{{( {I}_{rm s , P} )}^{2}} + \frac{{E}_{w , S}}{{( {I}_{rm s , S} )}^{2}} \qquad ( 13 )$$

$${L}_{lkPT} = \frac{{E}_{w , P} + {E}_{air , PT}}{{( {I}_{rm s , P} )}^{2}} + \frac{{E}_{w , T}}{{( {I}_{rm s , T} )}^{2}} \qquad ( 14 )$$

$${L}_{lkST} = \frac{{N}_{P}^{2}}{{N}_{S}^{2}} ( \frac{{E}_{w , S} + {E}_{air , ST}}{{( {I}_{rm s , S} )}^{2}} + \frac{{E}_{lkT}}{{( {I}_{rm s , T} )}^{2}} ) \qquad ( 15 )$$

These leakage inductances may next be converted to determine the transformer Y-equivalent circuit inductances using Equation 5, and then converted into A-equivalent circuit inductances to verify that the inductance values are acceptable for both power transfer and for the required ZVS range of the converter.

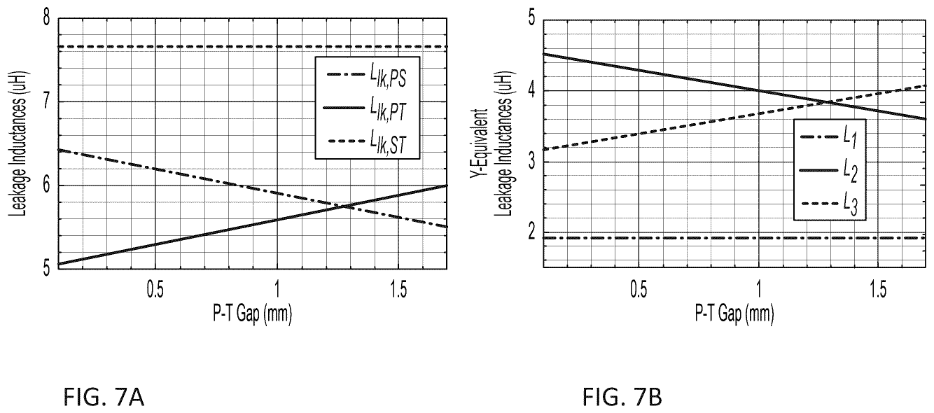

In verification of the analytical model for linking inductance developed in Equations 13-15, using the parameters listed in the transformer core datasheet as inputs, it is found, as shown in FIG. 7A, that, while maintaining the secondary-tertiary air gap distance to be constant at 3.94 mm and the air gap between the primary-tertiary windings variable (while taking into account the middle PCB thickness), the model results in 920 nH variation in the leakage inductances L_{ik,PS} and L_{ik,PT} and constant leakage inductance in L_{ik,ST} as expected. The comparatively large value of the L_{ik,ST} may be intuitively explained from the positioning of the secondary and tertiary winding PCBs at the two extreme ends of the transformer window, positioning that is not affected by the geometric position of the primary PCB. Transforming these leakage inductances into the Y-equivalent circuit of FIG. 3A results again in a 920 nH variation in L₂ and L₃, while L₁ is constant (1.912 μH), as per FIG. 7B. Although it is possible to design Case 1 to obtain matched linking inductances in L₁₂ and L₁₃ (which are affected most by L_{ik,PS} and L_{ik,PT}), one cannot design to maximize or minimize all inductances at once. Thus, there exists a trade-off between maximization and minimization and, foremost, the chosen ferrite core's window height imposes a design restriction on the upper limit of the realizable leakage design using such a winding configuration.

The non-ideal planar transformer core and winding power losses, which degrade achievable component power efficiency in the TAB converter, may also be considered. Due to the symmetry of the winding arrangement in Case 1 and the uniformity of the magnetic field distribution throughout the conductive PCB layers, an adequate estimate of the total winding loss in a non-interleaved planar transformer and the per layer resistance may be solved for by the modified Dowell's equation:

$${R}_{dc , m} = \frac{ρ {l}_{windinq}}{{A}_{windinq}} \qquad ( 16 )$$

$$\frac{{R}_{a c , m}}{{R}_{d c , m}} = \frac{ζ}{2} [ \frac{sinh ( ζ ) + sin ( ζ )}{cosh ( ζ ) - cos ( ζ )} + {( 2 m - 1 )}^{2} \frac{sinh ( ζ ) - sin ( ζ )}{cosh ( ζ ) + cos ( ζ )} ] \qquad ( 17 )$$

$$where m = \frac{F ( h )}{F ( h ) - F ( 0 )} and ζ = \frac{{h}_{c u}}{{δ}_{w}} .$$

Per layer resistance may be found by multiplying the R_{dc,m} by the coefficient found from Dowell's equation, and the total winding resistance may then be determined by summing the layer resistances, which are considered to be in series throughout the overall winding length:

$${R}_{X} = {\sum }_{m = 1}^{n} {R}_{a c , m , X} , X ∈ \{ P , S , T \} \qquad ( 18 )$$

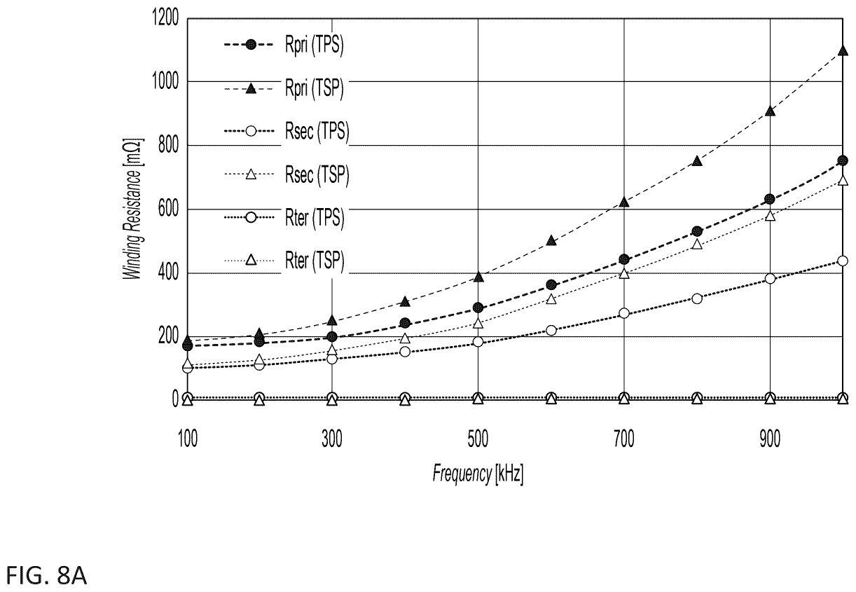

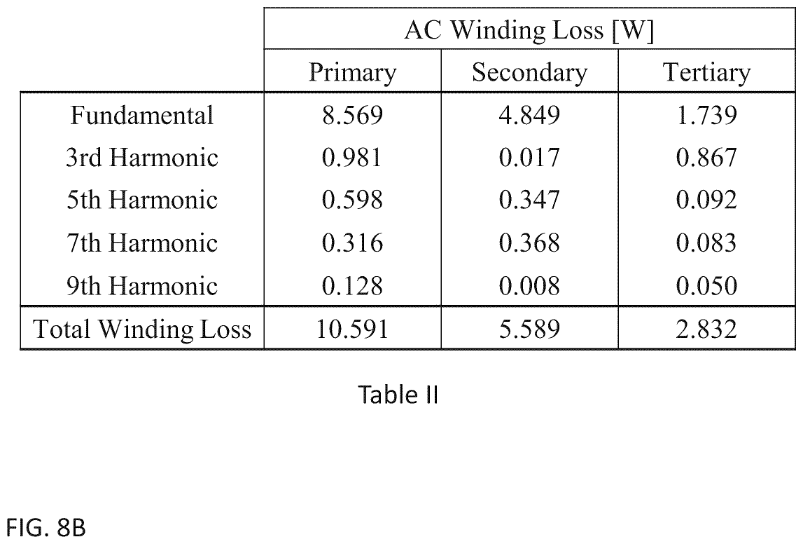

FIG. 8A provides the resultant winding resistances over frequency by use of winding parameters and the MMF distribution of FIG. 4 for the m variable in Equations 16 and 17. It may be deduced that winding resistances will increase parabolically in all three windings, with the non-parallel primary and secondary windings being the most affected by the skin depth over frequency in Equations 16-18, with the primary winding resistance increasing by 391% and secondary winding resistances 317% from 100 kHz to 1 MHz. The parallel winding arrangement of the tertiary side similarly results in an increase in winding resistance over frequency but, due to the equivalent circuit model being two parallel winding pairs in series, exhibits a far less drastic increase in resistance with only a 10.08% increase from 100 KHz to 1 MHz. It may also be noticed from FIG. 8A that each of the winding ac resistances would have increased substantially if the secondary PCB were sandwiched between the primary and tertiary ones instead of being positioned as shown in FIG. 4 (in a tertiary-primary-secondary configuration), due to a sharp increase in the peak MMF along the core window.

Due to high harmonic content in the TAB converter winding currents, a traditional calculation of winding loss with approximated sinusoidal current does not produce a precise loss result. Therefore, the accurate power loss induced in the transformer windings may be found using Equation 19 by multiplying the squared TAB winding RMS currents of the fundamental and its higher order harmonics with the total winding resistance associated with the respective switching harmonic component.

$${P}_{winding , X} = {\sum }_{h = 1}^{2 m + 1} {I}_{{X}_{h} , R MS}^{2} ( {R}_{X , h} ) , X ∈ \{ P , S , T \} \qquad ( 19 )$$

where I_{xp,RMS} is the h^{th} harmonic current RMS of TAB winding X, and R_{x,h} is the associated total ac resistance of winding X for h^{th} harmonic current. The RMS values of the fundamental and its higher order odd harmonic TAB winding current components primarily depend on the phase-shift control variables and may be deduced using the Fourier decomposition of the actual current waveshape, as discussed in Article 1. A winding loss calculation for the Case 1 transformer design, comparing the participation of the fundamental and higher order harmonic current components is depicted in Table II (FIG. 8B). Due to significant harmonic components in the TAB windings, up to 30% and 10% of total winding loss may occur due to the presence of 3^{rd} and 5^{th} order current harmonics, respectively. For this reason, the ac winding resistance minimization using interleaving may be used for any TAB transformer design, which significantly reduces the ac winding resistance at higher switching frequency harmonics.

Power loss arising from the transformer core due to change in magnetic flux may be analyzed as follows. The Dual Phase Shift (DPS) operation mode of a TAB converter in Article 1 is assumed to be operating with 50% duty ratio in each waveform and with TAB modulation variables ϕ₂ and ϕ₃ set per Table II of Article 1. The planar transformer core loss may then be estimated by considering the general expression for a continuous time-varying square waveform and solving for the magnetization voltage vₓ (t) in the Y-equivalent circuit of FIG. 3A by Equations 20 and 21:

$${v}_{i} ( t ) = {V}_{i} ( \frac{2 j}{π} ) ( {tanh}^{- 1} ( {e}^{- j π {f}_{s} ( f - {φ}_{i} )} ) - {tanh}^{- 1} ( {e}^{j π {f}_{s} ( f - {φ}_{i} )} ) ) \qquad ( 20 )$$

$${v}_{x} = {\sum }_{i = 1}^{n} \frac{{( {\sum }_{j = 1 , j \neq i}^{n} \frac{1}{{L}_{j}} )}^{- 1}}{{L}_{i} + {( {\sum }_{j = 1 , j \neq i}^{n} \frac{1}{{L}_{j}} )}^{- 1}} {v}_{i} \qquad ( 21 )$$

With these voltage waveform expressions, to estimate the core loss during TAB converter operation the Modified Steinmetz Equation (MSE) suffices for 50% duty ratio square wave operation considering the magnetic flux density from the expression for vₓ (in Equation 21).

$${P}_{core} = {f}_{s} ( {kf}_{eq}^{a - 1} {B}_{m}^{β} ) \qquad ( 22 )$$

$${f}_{eq} = \frac{2}{{B}_{pp}^{2} {π}^{2}} {\int }_{0}^{{T}_{s}} {( \frac{dB}{dt} )}^{2} dt \qquad ( 23 )$$

(α,β and k) constants are provided from the transformer core manufacturer (1.496, 2.548 and 46.6, respectively for ambient temperature) and Bₚₚ, Bₘ and dB/dt are determined by solving for flux density considering the approximate vₓ(t) waveform.

$${B}_{pp} = 2 ( \frac{{Φ}_{2} ( {V}_{1} - {V}_{2} - {V}_{3} )}{3 {A}_{core} ( {N}_{P} + {N}_{S} + {N}_{T} )} + \frac{{Φ}_{3} ( {V}_{1} + {V}_{2} - {V}_{3} )}{3 {A}_{core} ( {N}_{P} + {N}_{S} + {N}_{T} )} + \frac{( \frac{{T}_{s}}{2} - {Φ}_{3} - {Φ}_{2} ) ( {V}_{1} + {V}_{2} + {V}_{3} )}{3 {A}_{core} ( {N}_{P} + {N}_{S} + {N}_{T} )} ) \qquad ( 24 )$$

$${B}_{m} = \frac{{B}_{pp}}{2} \qquad ( 25 )$$

$$\frac{dB}{dt} = \frac{{v}_{x} ( t )}{{A}_{core} ( {N}_{P} + {N}_{S} + {N}_{T} )} \qquad ( 26 )$$

Thus, the total core loss with such a TAB transformer, when employed to support a total load of 1.2 KW, is obtained as 17.46 W.

### B. Case 2: Side Limb Wound Transformer Design

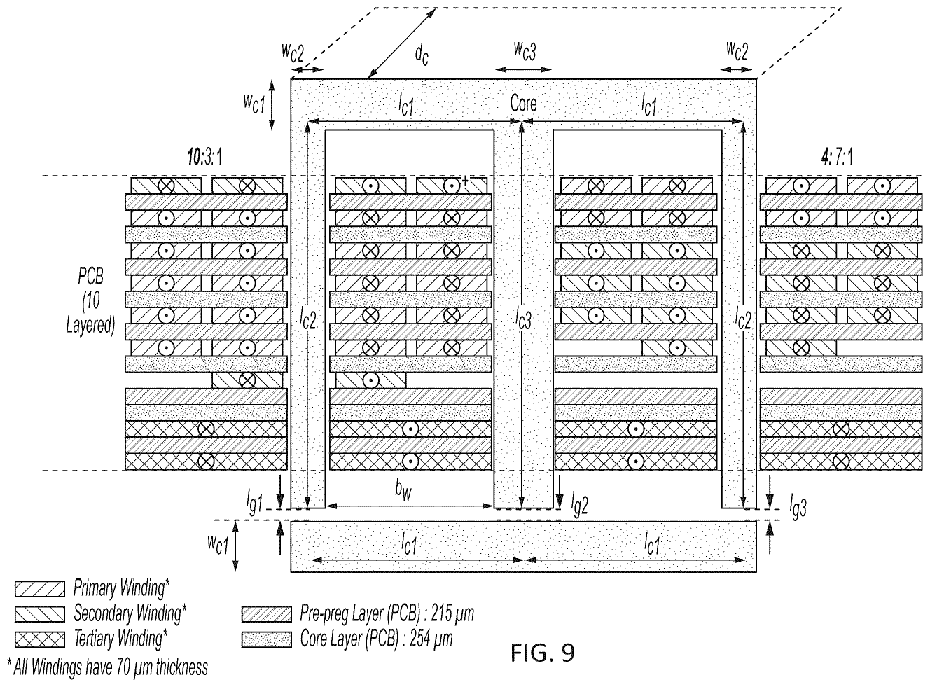

In the Case 1 design, the leakage inductance is created by physically distancing the winding PCBs. Because the height of the planar transformer is limited, the maximum leakage inductance achievable in a Case 1 design may also be limited, and the Case 1 design may fail to result in sufficient leakage inductance. In part for this reason, a side limb wound split winding transformer design is analyzed in Case 2, illustrated in FIG. 9. Such a design differs from that in Case 1 with respect to planar winding placement and the way the resultant integrated TAB leakage inductances are coupled via the transformer air gaps, realized by arranging for each turn of the planar windings to encircle one or the other of the outer limbs, resulting in a differential leakage flux through the center limb. The benefit of having a design in which the leakage energy is coupled through differential core flux is the ability to interleave the planar windings without sacrificing the required integrated leakage inductances, allowing for improved (reduced) power loss in the windings. In the Case 2 design, an original three winding transformer with a turns ratio of Nₚ:Nₛ:Nₜ is first split into two separate transformers with turns ratios of Nₚ₁:Nₛ₁:Nᵤ₁ and Nₚ₂:Nₛ₂:Nₜ₂, where Nₚ=Nₚ₁+Nₚ₂, Nₛ=Nₛ₁+Nₛ₂ and Nₜ=Nₜ₁+Nₜ₂. Each of these two elemental transformers is wound around a respective outer limb of the ‘E’ core as shown in FIG. 9 instead of being wound around the central limb, as in the Case 1 design. Now, by (i) series connection of the primary, secondary and tertiary turns of the two elemental transformers, which ensures the same current through all the similar windings, and (ii) adding a controllable central limb air gap, the desired leakage inductance may be achieved. Such a winding design removes the requirement of a multiple PCB based winding design, with all windings instead fitting onto a single 10-layered PCB. The PCB of FIG. 9 is a 10-layered PCB in that it includes 9 dielectric layers (and, as such, is capable of accommodating 10 conductive (e.g., copper) layers). In the embodiment of FIG. 9, however, one of these conductive layers is unused (e.g., absent), between the lowest core layer and the pre-preg layer immediately above it, so that these two dielectric layers abut directly against each other without an intervening conductive layer.

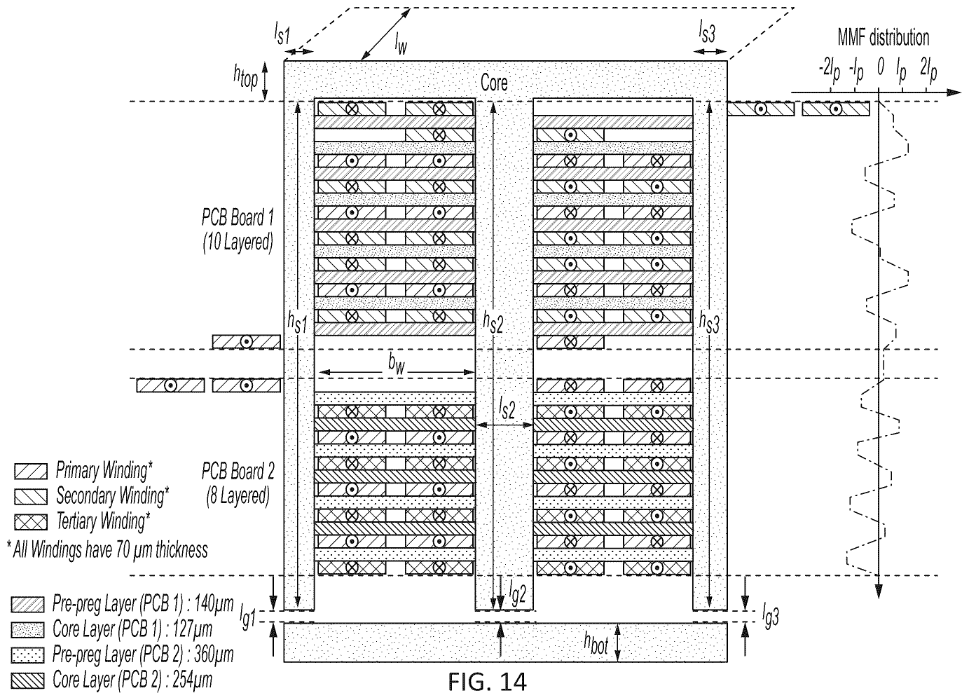

As a result of constructing the windings in this manner, both the magnetizing and leakage inductances of the transformer are dominated by the core and air gap reluctances, with minimal leakage energy coupled between windings. As shown in FIG. 9, the Case 2 transformer has a primary winding and a secondary winding each of which has turns asymmetrically distributed between a first outer limb (the outer limb on the left in FIG. 9) and a second outer limb (the outer limb on the right in FIG. 9). In Case 2, each of two of the PCB layers including the secondary winding (the layer containing the lowest and second-lowest turns of the secondary winding, in FIG. 9), contains exactly one turn of the secondary winding, encircling a respective one of the outer limbs. Encirclement is defined with respect to a central plane that passes through the transformer (e.g., the cutting plane of FIGS. 4, 5B, 9, and 14). As used herein, that a turn of a winding “encircles” a limb set (e.g., encircles a limb, or encircles a plurality of limbs) means that the turn passes through the central plane on one side of the limb set in a first direction and the turn passes through the central plane on the other side of the limb set in a second direction, opposite the first direction, wherein the limb set is the greatest set of limbs encircled. As such, in the embodiment of FIG. 14 (discussed in further detail below), a first one (e.g., the smaller, inner one) of the topmost turns of the secondary winding may be said to encircle the central limb and the right outer limb, but it may not be said to encircle, e.g., the right outer limb, because the right outer limb is not the greatest set of limbs encircled by the turn.

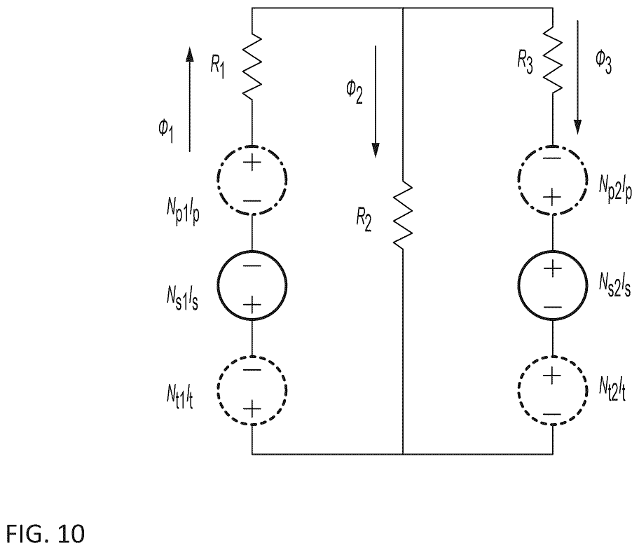

FIG. 10 presents the equivalent magnetic circuit model, which may be solved by Equations 27-29 for the fluxes belonging to the ferrite core, with @1 and @3 representing the magnetizing flux and @2 the differential leakage flux that is flowing through the central limb of the transformer.

$${Φ}_{1} = \frac{\begin{matrix}{I}_{P} ( {N}_{P 1} {R}_{2} + {N}_{P 1} {R}_{3} + {N}_{P 2} {R}_{2} ) - {I}_{S} ( {N}_{S 1} {R}_{2} + \\ {N}_{S 1} {R}_{3} + {N}_{S 2} {R}_{2} ) - {I}_{T} ( {N}_{T 1} {R}_{2} + {N}_{T 1} {R}_{3} + {N}_{T 2} {R}_{2} )\end{matrix}}{{R}_{1} {R}_{2} + {R}_{2} {R}_{3} + {R}_{1} {R}_{3}} \qquad ( 27 )$$

$${Φ}_{2} = \frac{{I}_{P} ( {N}_{P 1} {R}_{3} - {N}_{P 2} {R}_{1} ) - {I}_{S} ( {N}_{S 1} {R}_{3} - {N}_{S 2} {R}_{1} ) - {I}_{T} ( {N}_{T 1} {R}_{3} - {N}_{T 2} {R}_{1} )}{{R}_{1} {R}_{2} + {R}_{2} {R}_{3} + {R}_{1} {R}_{3}} \qquad ( 28 )$$

$${Φ}_{3} = \frac{\begin{matrix}{I}_{P} ( {N}_{P 2} {R}_{1} + {N}_{P 2} {R}_{2} + {N}_{P 1} {R}_{2} ) - {I}_{S} ( {N}_{S 2} {R}_{1} + \\ {N}_{S 2} {R}_{2} + {N}_{S 1} {R}_{2} ) - {I}_{T} ( {N}_{T 2} {R}_{1} + {N}_{T 2} {R}_{2} + {N}_{T 1} {R}_{2} )\end{matrix}}{{R}_{1} {R}_{2} + {R}_{2} {R}_{3} + {R}_{1} {R}_{3}} \qquad ( 29 )$$

Again, referring to core and air gap geometry the reluctances of the magnetic circuit model may be calculated from Equations 30-32:

$${R}_{1} = 2 {R}_{lc 1} + {R}_{lc 2} + {R}_{lg 1} \qquad ( 30 )$$

$${R}_{2} = {R}_{lc 3} + {R}_{lg 2} \qquad ( 31 )$$

$${R}_{3} = 2 {R}_{lc 1} + {R}_{lc 2} + {R}_{lg 1} \qquad ( 32 )$$

Further, to calculate the self and mutual inductances of the elemental transformers, the flux linkages associated with the separate windings may be obtained utilizing the superposition theorem. Considering the excitation of only the primary winding, the flux flowing in the three core legs of the E core may be obtained as

$${Φ}_{1 , p} = {I}_{p} [ \frac{{R}_{2} ( {N}_{p 1} + {N}_{p 2} ) + {N}_{p 1} {R}_{3}}{{R}_{1} {R}_{2} + {R}_{2} {R}_{3} + {R}_{1} {R}_{3}} ] \qquad ( 33 )$$

$${Φ}_{2 , p} = {I}_{p} [ \frac{{N}_{p 1} {R}_{3} - {N}_{p 2} {R}_{1}}{{R}_{1} {R}_{2} + {R}_{2} {R}_{3} + {R}_{1} {R}_{3}} ] \qquad ( 34 )$$

$${Φ}_{3 , p} = {I}_{p} [ \frac{{R}_{2} ( {N}_{p 1} + {N}_{p 2} ) + {N}_{p 2} {R}_{1}}{{R}_{1} {R}_{2} + {R}_{2} {R}_{3} + {R}_{1} {R}_{3}} ] . \qquad ( 35 )$$

Now, the self flux linkages App and mutual flux linkages Aps may be derived from Equation 36 and Equation 37, respectively:

$${λ}_{p , p} = {N}_{p 1} {Φ}_{1 , p} + {N}_{p 2} {Φ}_{3 , p} \qquad ( 36 )$$

$${λ}_{p , s} = {N}_{s 1} {Φ}_{1 , p} + {N}_{s 2} {Φ}_{3 , p} \qquad ( 37 )$$

Thus, the self and mutual inductances with the primary winding excited may be solved as:

$${L}_{p , p} = \frac{{λ}_{p , p}}{{I}_{p}} = \frac{{N}_{p 2}^{2} {R}_{1} + {N}_{p 1}^{2} {R}_{3} + {( {N}_{p 1} + {N}_{p 2} )}^{2} {R}_{2}}{{R}_{1} {R}_{2} + {R}_{2} {R}_{3} + {R}_{1} {R}_{3}} \qquad ( 38 )$$

$${M}_{p , s} = \frac{{λ}_{p , s}}{{I}_{p}} . \qquad ( 39 )$$

From Equations 38 and 39, the Y-model leakage inductance of the primary side of the transformer may be formulated as

$${L}_{lk , p} = {L}_{p , p} - {M}_{p , s} \frac{{N}_{p 1} + {N}_{p 2}}{{N}_{s 1} + {N}_{s 2}} = \frac{{N}_{p 1} ( {N}_{p 1} {N}_{s 2} - {N}_{p 2} {N}_{S 1} ) {R}_{3} - {N}_{p 2} ( {N}_{p 1} {N}_{s 2} - {N}_{p 2} {N}_{S 1} ) {R}_{1}}{( {N}_{s 1} + {N}_{s 2} ) ( {R}_{1} {R}_{2} + {R}_{2} {R}_{3} + {R}_{1} {R}_{3} )} . \qquad ( 40 )$$

Similarly, upon excitation of secondary and tertiary windings, their individually contributed leakage inductances L_{lk,s} and L_{lk,t} may be also derived, as shown in Equations 41-42.

$${L}_{lk , s} = \frac{{N}_{s 1} ( {N}_{p 2} {N}_{s 1} - {N}_{p 1} {N}_{s 2} ) {R}_{3} - {N}_{s 2} ( {N}_{s 1} {N}_{p 2} - {N}_{s 2} {N}_{p 1} ) {R}_{1}}{( {N}_{p 1} + {N}_{p 2} ) ( {R}_{1} {R}_{2} + {R}_{2} {R}_{3} + {R}_{1} {R}_{3} )} \qquad ( 41 )$$

$${L}_{lk , t} = \frac{{N}_{t 1} ( {N}_{p 2} {N}_{t 1} - {N}_{p 1} {N}_{t 2} ) {R}_{3} - {N}_{t 2} ( {N}_{t 1} {N}_{p 2} - {N}_{t 2} {N}_{p 1} ) {R}_{1}}{( {N}_{p 1} + {N}_{p 2} ) ( {R}_{1} {R}_{2} + {R}_{2} {R}_{3} + {R}_{1} {R}_{3} )} \qquad ( 42 )$$

Furthermore, in case of similar side limb air gaps, i.e., l_{g1}=l_{g3}, or R₁=R₃, the individual TAB port leakage inductances (L₁, L′₂ and L′₃) become

$${L}_{1} = \frac{( {N}_{p 1} - {N}_{p 2} ) ( {N}_{p 1} {N}_{s 2} - {N}_{p 2} {N}_{s 1} ) {R}_{1}}{( {N}_{s 1} + {N}_{s 2} ) ( {R}_{1} {R}_{2} + {R}_{2} {R}_{3} + {R}_{1} {R}_{3} )} \\ {L}_{2}^{′} = \frac{( {N}_{s 1} - {N}_{s 2} ) ( {N}_{p 2} {N}_{s 1} - {N}_{p 1} {N}_{s 2} ) {R}_{1}}{( {N}_{p 1} + {N}_{p 2} ) ( {R}_{1} {R}_{2} + {R}_{2} {R}_{3} + {R}_{1} {R}_{3} )} \\ {L}_{3}^{′} = \frac{( {N}_{t 1} - {N}_{t 2} ) ( {N}_{p 2} {N}_{t 1} - {N}_{p 1} {N}_{t 2} ) {R}_{1}}{( {N}_{p 1} + {N}_{p 2} ) ( {R}_{1} {R}_{2} + {R}_{2} {R}_{3} + {R}_{1} {R}_{3} )} . \qquad ( 43 )$$

It is observable from Equation 43 that for an equal distribution of any of the winding turns, i.e., Nₚ₁=Nₚ₂ Or, Nₛ₁=Nₛ₂ or, Nₜ₁=Nₜ₂, the other series winding does not contribute any leakage inductance. Hence, with an asymmetric distribution of the winding turns a desired leakage inductance may be achieved through a core-coupled transformer design. Additionally, when R₂>>R₁, or the side limbs of the core have minimal air gap compared to the central limb, the leakage inductances of Equation 43 may be further simplified to

$${L}_{1} = \frac{( {N}_{p 1} - {N}_{p 2} ) ( {N}_{p 1} {N}_{s 2} - {N}_{p 2} {N}_{S 1} )}{2 ( {N}_{s 1} + {N}_{s 2} ) {R}_{2}} \\ {L}_{2}^{′} = \frac{( {N}_{s 1} - {N}_{s 2} ) ( {N}_{p 2} {N}_{s 1} - {N}_{p 1} {N}_{s 2} )}{2 ( {N}_{p 1} + {N}_{p 2} ) {R}_{2}} \\ {L}_{3}^{′} = \frac{( {N}_{t 1} - {N}_{t 2} ) ( {N}_{p 2} {N}_{t 1} - {N}_{p 1} {N}_{t 2} )}{2 ( {N}_{p 1} + {N}_{p 2} ) {R}_{2}} . \qquad ( 44 )$$

From Equation 44, it may be concluded that the leakage inductances of the individual TAB ports may be controlled by (1) varying the central limb air gap l_{g2} or its cross-sectional area, which changes R₂, or (2) varying the asymmetry in winding turn distribution, which changes (Nₚ₁−Nₚ₂) (Nₚ₁Nₛ₂−Nₚ₂Nₛ₁) (for the primary). Further, for a particular desired leakage inductance, if the asymmetry in winding turns is increased, the leakage flux density in the central limb decreases, causing lower core loss. Also, with more asymmetry in the winding turns, the interleaving of the magnetic structure is further interrupted, resulting in higher ac winding loss due to higher proximity effect. This trade-off between the core loss and winding loss with variation in winding distribution asymmetry forms the basis of design optimization for the Case 2 design.

The magnetizing inductance of the transformer referred to the primary side may also be derived, as (assuming R₂>>R₁=R₃):

$${L}_{m , p} = {M}_{p , s} \frac{{N}_{p 1} + {N}_{p 2}}{{N}_{s 1} + {N}_{s 2}} = \frac{{( {N}_{p 1} + {N}_{p 2} )}^{2}}{2 {R}_{1}} \qquad ( 45 )$$

It may be observed from Equation 45 that the magnetizing inductance is not influenced by the distribution of the winding turns or the central limb air gap. This occurs because the magnetizing flux linking all the winding turns flows through the outer limbs of the E core, making the magnetizing inductance controllable by the outer limb reluctance R₁ only. Also, the magnetic flux flowing in the three limbs of the E core as deduced in Equations 27-29 is a combined effect of the magnetizing flux and the leakage flux flowing in the core, as shown in Equation 46:

$${Φ}_{1} = \frac{{R}_{2}}{2 {R}_{1} {R}_{2} + {R}_{1}^{2}} [ ( {N}_{p 1} + {N}_{p 2} ) {I}_{p} - ( {N}_{s 1} + {N}_{s 2} ) {I}_{s} - ( {N}_{t 1} + {N}_{t 2} ) {I}_{t} ] + \frac{{N}_{p 1} {I}_{p} - {N}_{s 1} {I}_{s} - {N}_{t 1} {I}_{t}}{2 {R}_{2} + {R}_{1}} \\ {Φ}_{2} = \frac{( {N}_{p 1} {I}_{p} - {N}_{s 1} {I}_{s} - {N}_{t 1} {I}_{t} ) + ( {N}_{p 2} {I}_{p} - {N}_{s 2} {I}_{s} - {N}_{t 2} {I}_{t} )}{2 {R}_{2} + {R}_{1}} \\ {Φ}_{3} = \frac{{R}_{2}}{2 {R}_{1} {R}_{2} + {R}_{1}^{2}} [ ( {N}_{p 1} + {N}_{p 2} ) {I}_{p} - ( {N}_{s 1} + {N}_{s 2} ) {I}_{s} - ( {N}_{t 1} + {N}_{t 2} ) {I}_{t} ] - \frac{{N}_{p 2} {I}_{p} - {N}_{s 2} {I}_{s} - {N}_{t 2} {I}_{t}}{2 {R}_{2} + {R}_{1}} . \qquad ( 46 )$$

The magnetizing flux component (the term

$$\frac{{R}_{2}}{2 {R}_{1} {R}_{2} + {R}_{1}^{2}} [ ( {N}_{p 1} + {N}_{p 2} ) {I}_{p} - ( {N}_{s 1} + {N}_{s 2} ) {I}_{s} - ( {N}_{t 1} + {N}_{t 2} ) {I}_{t} ]$$

in the expressions for ϕ₁ and ϕ₃) in Equation 46 circulates around the outer limbs of the transformer core. Nonetheless, the leakage flux is distributed among all the limbs of the E core originating from the central limb. Thus, these two fluxes add up in one of the outer limbs, while they mutually cancel out in the other side limb, resulting in a non-uniform magnetic core flux density distribution among the three limbs of the core, as may be observed from FEA simulation results.

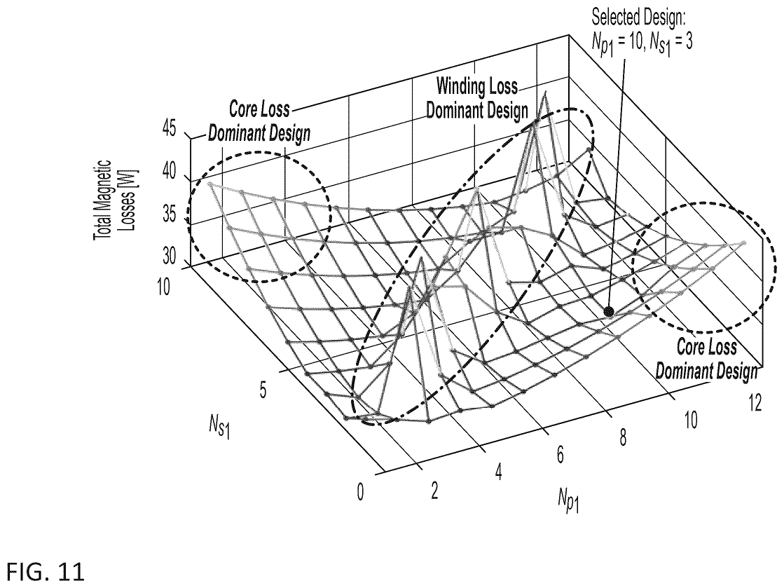

Once the analytical expressions of the leakage and magnetizing inductances and the magnetic fluxes in individual core limbs are constructed, the least magnetic loss (i.e., winding+core loss) based Case 2 transformer design may be obtained by optimizing the winding turn distribution. To make the optimization procedure easier, the low voltage TAB port or the tertiary winding may be equally distributed among the two side limbs or, Nₜ₁=Nₜ₂, making the analytically obtained tertiary side inductance 0, as per Equation 44. This may also be done to attain a lower value of L′₃ that may decouple the two TAB ports while the primary and secondary ports contribute the major leakage inductances required for the design. The magnetic loss-based design optimization result is shown in FIG. 11, where the combined core and winding loss of the transformer is shown for different combinations of primary and secondary winding distributions that achieves the same leakage inductances with the given core geometry and corresponding central limb air gap. Here, the core loss in the magnetic structure is obtained from the formulated flux density information in Equation 46, using the Steinmetz parameters of the core material and application of the improved Generalized Steinmetz Equation (iGSE). The individual core loss per volume of the two side limbs and the central limb may be calculated separately and then summed together to determine the total core induced power loss in Equation 47:

$${P}_{core , total} = {\sum }_{k = 1}^{{n}_{Vol}} {P}_{core , k} , X ∈ \{ {Vol}_{1} , {Vol}_{2} , {Vol}_{3} \} \qquad ( 47 )$$

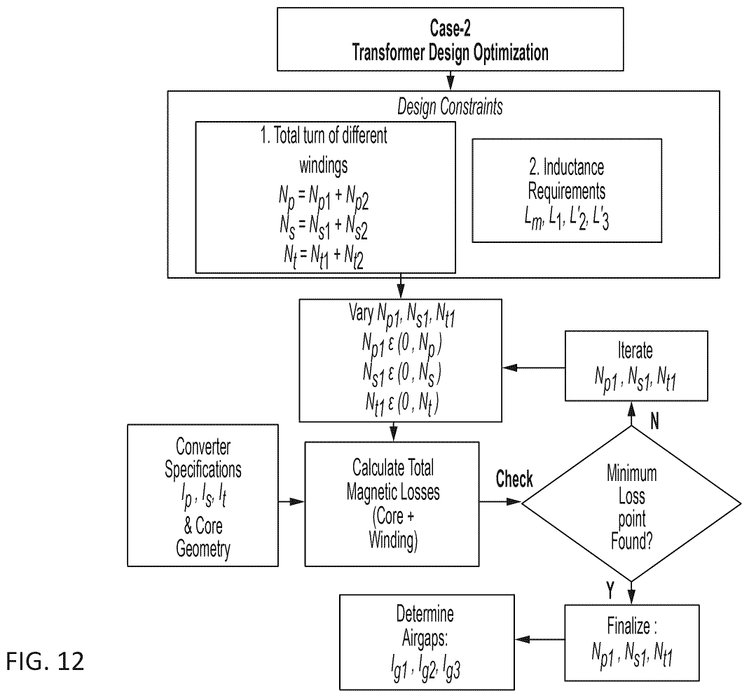

From Equation 47 it is found that large asymmetrical designs exhibit minimal core losses due to their relatively large central limb air gap, resulting in low leakage flux density. Further, ac winding losses may be calculated using the 1-D Dowell's equations of Equation 17 within the same design space of Nₚ and Nₛ. Thus, the ac winding loss follows the opposite trend of the core loss in the transformer where symmetric designs have the least ac resistance. However, due to the non-uniform magnetic field distribution around the windings, the modified 1-D Dowell's expression of Equation 17 will not be accurate in this winding configuration. A 2-D solution may be sufficiently accurate, but the 2-D solution for winding loss calculation may be challenging. Thus, a 3D finite element model (FEM) simulation study has also been carried out to determine the ac resistances of the windings and the associated losses for the Case 2 design. Finally, by searching for the least total magnetic loss operating point in the plot of FIG. 11, the Case 2 transformer design may be finalized as: Nₚ₁₌₁₀, Nₚ₂=4; Nₛ₁=3, Nₛ₂₌₇; and Nₜ₁₌₁, Nₜ₂₌₁. The complete optimization procedure for such a leakage integrated transformer design is presented in the form of a flow chart in FIG. 12.

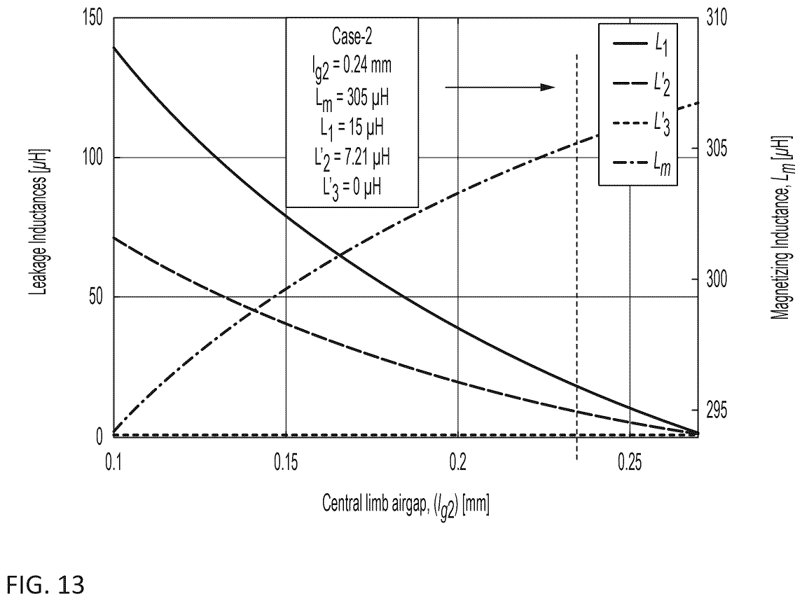

FIG. 13 presents the results of Equations 33-34 while considering the core geometry parameters, outer core gap l_{g1} held constant at 0.01 mm, and center core gap l_{g2} variable from 0.1 mm to 0.27 mm. It may be observed from the figure that the central leg core gap drastically affects the leakage inductance values; however, it does not reveal a large variation with Lₘ=294.5 μH and Lₘ=307 μH for lg₂=0.1 mm and lg₂=0.27 mm, respectively. From these results it is evident that a wider range of TAB leakage inductances may be designed for when the leakage energy is confined by the core instead of the air at the window region. Thus, a wider range of converter ZVS over a required range voltage transfer ratios is possible in Case 2, along with large controllable leakage inductance values attainable for high power transfer between TAB transformer ports. However, one drawback in this design is that due to high sensitivity of Lₖ values over the l_{g2},

$$( \frac{Δ {L}_{k}}{Δ {l}_{{g}_{2}}} ) ,$$

perfectly designing such a transformer with desirable inductances is challenging from a practical implementation point of view. With the Case 2 TAB transformer design, a Lₘ of 307 μH and individual leakage inductances L₁−L₃ of 15 μH, 7.21 μH and 0 μH, respectively, are realized with core air gap lengths of l_{g1}=l_{g3}=0.1 mm and lg₂=0.24 mm.
C. Case 3: Hybrid Central and Side Limb wound Transformer Design

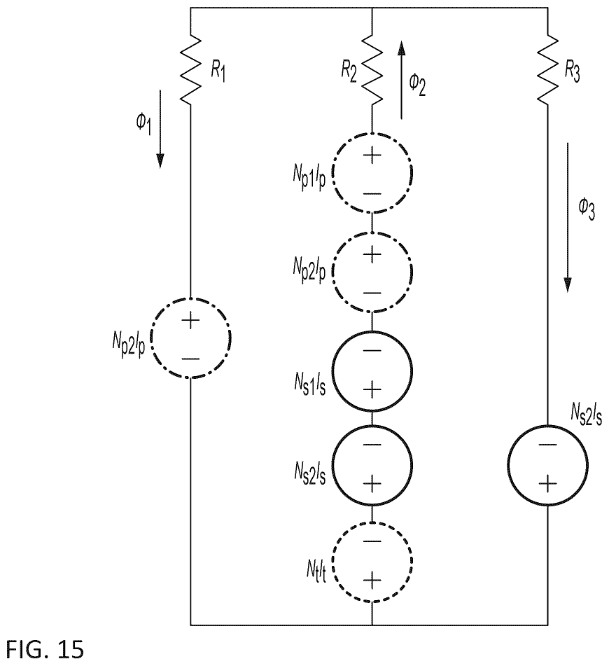

Although the Case 2 design demonstrates the advantage of utilizing a differential magnetic flux contained within the transformer core so as to attain large port leakage inductances, and its usefulness in realizing leakage, the implementation of such a transformer is challenging in terms of manufacturability due to the observed high sensitivity of the leakage inductance with respect to the variance in core air gap length. As such, to realize a more stable leakage inductance in a TAB transformer structure while utilizing the interleaved winding fashion and thus, minimizing the ac resistances, a winding approach, as the Case 3 design, is disclosed here, where a certain fraction of the total number of primary and secondary turns surround both the central and side limbs of an E-core (e.g., an E-E core). This winding arrangement is depicted in FIG. 14, with the corresponding magnetic circuit model presented in FIG. 15. Here, Nₚ₂ and Nₛ₂ primary and secondary turns are wound around the left and central limb, and right and central limb, respectively. The remainder of the primary (Nₚ₁), secondary (Nₛ), and tertiary (Nₜ) winding concentric turns are made on the central limb only. Solving the magnetic equivalent circuit, the fluxes flowing in each of the core limbs may be derived using Equations 48-50.

$${Φ}_{1} = \frac{{I}_{P} ( {N}_{P 1} {R}_{3} - {N}_{P 2} {R}_{2} ) - {I}_{S} ( {N}_{S 2} {R}_{2} + {N}_{S 1} {R}_{3} + {N}_{S 1} {R}_{3} ) - {I}_{T} ( {R}_{3} {N}_{T} )}{{R}_{1} {R}_{2} + {R}_{2} {R}_{3} + {R}_{3} {R}_{1}} \qquad ( 48 )$$

$${Φ}_{2} = \frac{\begin{matrix}{I}_{P} ( {N}_{P 1} {R}_{1} + {N}_{P 1} {R}_{3} + {N}_{P 2} {R}_{1} ) - {I}_{S} ( {N}_{S 1} {R}_{1} + \\ {N}_{S 1} {R}_{3} + {N}_{S 2} {R}_{3} ) - {I}_{T} ( {N}_{T} {R}_{1} + {N}_{T} {R}_{3} )\end{matrix}}{{R}_{1} {R}_{2} + {R}_{2} {R}_{3} + {R}_{3} {R}_{1}} \qquad ( 49 )$$

$${Φ}_{3} = \frac{{I}_{P} ( {N}_{P 1} {R}_{1} + {N}_{p 2} {R}_{1} + {N}_{P 2} {R}_{2} ) + {I}_{S} ( {N}_{S 2} {R}_{2} - {N}_{S 1} {R}_{1} ) - {I}_{T} ( {R}_{1} {N}_{T} )}{{R}_{1} {R}_{2} + {R}_{2} {R}_{3} + {R}_{3} {R}_{1}} \qquad ( 50 )$$

where R₁, R₂ and R₃ represent the reluctances of the left, central and right limb of the transformer core, as stated above. The magnetizing flux in such a magnetic structure flows in the central limb which couples all the three windings. Further, the equivalent turns ratio or the current transfer ratio between the primary, secondary and tertiary side of this three winding transformer may be deduced by comparing central limb magnetic flux (Equation 49) with 2=Nₚ′Iₚ−N′ₜ−N′lₜ, where the equivalent turns ratio is given by Equation 51

$${N}_{P}^{′} : {N}_{S}^{′} : {N}_{T}^{′} = ( {N}_{P 1} {R}_{1} + {N}_{P 1} {R}_{3} + {N}_{P 2} {R}_{1} ) : ( {N}_{S 1} {R}_{1} + {N}_{S 1} {R}_{3} + {N}_{S 2} {R}_{3} ) : ( {N}_{T} {R}_{1} + {N}_{T} {R}_{3} ) \qquad ( 51 )$$

In case of similar side limb air gap, e.g., l_{g1}=l_{gs}, this ratio simplifies to (2N_{P1}+Nₚ₂):(2N_{S1}+N_{S2}):(2N_{T}). The distribution of the winding turns in such a design may be done with a target of maintaining this current transfer ratio to be nearly equal to the ratio of the TAB ports' nominal dc link voltages, i.e.,

$$( 2 {N}_{P 1} + {N}_{P 2} ) : ( 2 {N}_{S 1} + {N}_{S 2} ) : ( 2 {N}_{T} ) = 160 : 120 : 28 \qquad ( 52 )$$

There may be a few possible winding distributions that match this target and those may be considered for further optimization of the magnetic losses in order to choose the optimal design.

Considering the equivalent turns ratio of Equation 51, the magnetizing and leakage inductance of the primary and secondary sides of the transformer may be calculated using Equation 53:

$${L}_{m} = ( \frac{{N}_{P 1} {R}_{1} + {N}_{P 1} {R}_{3} + {N}_{P 2} {R}_{1}}{{N}_{T} ( {R}_{1} + {R}_{3} )} ) ( \frac{[ ( {N}_{P 1} + {N}_{P 2} ) {Φ}_{2} - {N}_{P 2} {Φ}_{1} ] {\vert}_{{I}_{p} = {I}_{s} = oA}}{- {I}_{T}} ) = \frac{{( {N}_{P 1} ( {R}_{1} + {R}_{3} ) + {N}_{P 2} {R}_{1} )}^{2}}{( {R}_{1} + {R}_{3} ) ( {R}_{1} {R}_{2} + {R}_{2} {R}_{3} + {R}_{3} {R}_{1} )} = \frac{{( {N}_{{P}_{2}} + 2 {N}_{{P}_{1}} )}^{2}}{2 ( 2 {R}_{2} + {R}_{1} )} ( if {R}_{1} = {R}_{3} ) {L}_{1} = \frac{[ {Φ}_{2} ( {N}_{P 1} + {N}_{P 2} ) - {Φ}_{1} {N}_{P 2} ] {\vert}_{{I}_{S} = {I}_{T} = oA}}{{I}_{P}} - {L}_{m} = \frac{{N}_{P 2}^{2}}{{R}_{1} + {R}_{3}} \\ {L}_{2}^{′} = \frac{[ {Φ}_{2} ( {N}_{S 1} + {N}_{S 2} ) - {Φ}_{1} {N}_{S 2} ] {\vert}_{{I}_{S} = {I}_{T} = oA}}{- {I}_{S}} - {L}_{m} = \frac{{N}_{S 2}^{2}}{{R}_{1} + {R}_{3}} \\ {L}_{3}^{′} = \frac{[ {Φ}_{2} {N}_{T} ] {\vert}_{{I}_{P} = {I}_{S} = oA}}{- {I}_{T}} - {L}_{m} = 0 \qquad ( 53 )$$

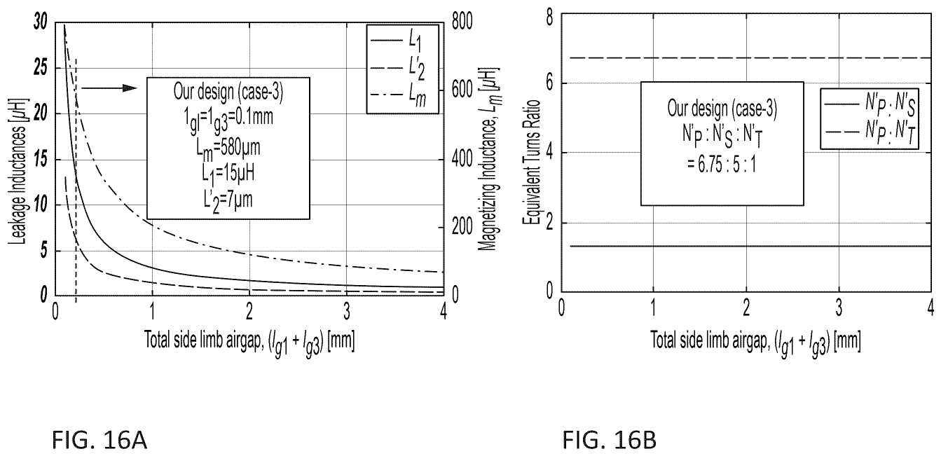

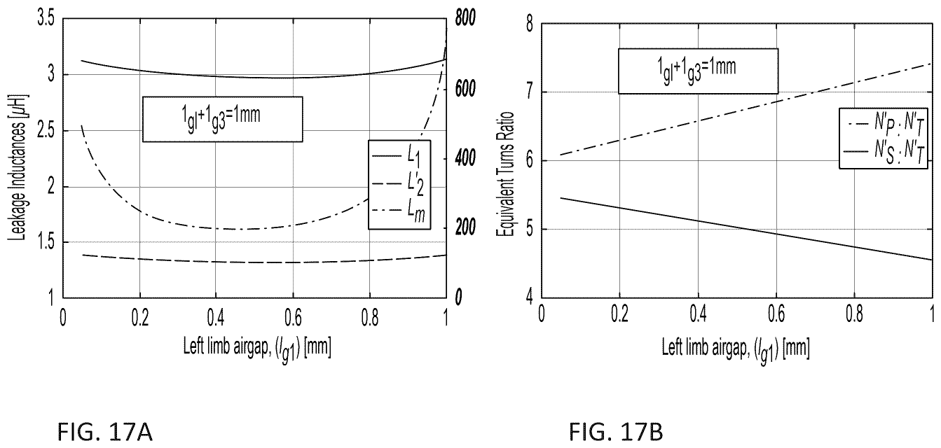

Accordingly, it may be inferred from the resultant Case 3 transformer parameter expressions of Equation 53 that the leakage inductances of the primary and secondary side individually may be minutely controlled by the following two methods: (a) by varying the total side limb air gap (lg, +l_{g3}), while maintaining the current transfer ratio between the windings constant, as demonstrated in FIGS. 16A and 16B, and (b) by changing the number of turns of the primary and secondary windings (Nₚ₂ and Nₛ₂), which circulate through the central and outer limb of the E core. Furthermore, in the Case 3 design, the leakage flux is produced due to the Nₚ₂ and Nₛ₂ winding turns, and it circulates through the outer limbs of the core. Further, for a particular desired leakage inductance, if the Nₚ₂ and Nₛ₂ turns are increased, the leakage flux density in the outer limb decreases due to higher required outer limb air gap causing reduced core loss due to leakage flux. Also, with more asymmetry in the winding turns, i.e., higher Nₚ₂ and Nₛ₂, the interleaving of the winding structure is further interrupted, resulting in higher ac winding loss due to higher proximity effect. Similar to the Case 2 design, this trade-off between the core loss and winding loss with variation in winding distribution asymmetry provides scope for design optimization for such a leakage integrated TAB transformer design. However, as the Nₚ₂ and Nₛ₂ windings pass surrounding the central limb, the interleaving in the Case 3 design is less disturbed than in the Case 2 transformer design. Furthermore, in the Case 3 transformer design, if one of the side limb air gaps is varied while keeping the sum of the side limb gaps constant, the equivalent turns ratio of the converter may be linearly varied while conserving nearly the same leakage inductances (FIGS. 17A and 17B). Moreover, the air gap in the central limb does not affect the leakages, rather it only influences the magnetizing inductance.

The magnetic flux in the three limbs of the E core, as determined in Equations 48-50, is a result of both the magnetizing flux and the leakage flux flowing within the core. To enhance comprehensibility of this phenomenon, the individual fluxes ϕ₁, ϕ₂, and ϕ₃ may be expressed as a combination of the magnetizing and leakage fluxes, as illustrated in Equation 54 (under the assumption that R₁=R₃).

$${Φ}_{1} = \frac{{N}_{p 1} {I}_{p} - ( {N}_{s 1} + {N}_{s 2} ) {I}_{s} - {N}_{t} {I}_{t}}{{R}_{1} + 2 {R}_{2}} - \frac{( {I}_{p} {N}_{p 2} + {I}_{s} {N}_{s 2} ) {R}_{2}}{{R}_{1} {R}_{2} + {R}_{2} {R}_{3} + {R}_{3} {R}_{1}} \\ {Φ}_{2} = \frac{( 2 {N}_{p 1} + {N}_{p 2} ) {I}_{p} - ( 2 {N}_{s 1} + {N}_{s 2} ) {I}_{s} - 2 {N}_{t} {I}_{t}}{{R}_{1} + 2 {R}_{2}} \\ {Φ}_{3} = \frac{( {N}_{p 1} + {N}_{p 2} ) {I}_{p} - {N}_{s 1} {I}_{s} - {N}_{t} {I}_{t}}{{R}_{1} + 2 {R}_{2}} + \frac{( {I}_{p} {N}_{p 2} + {I}_{s} {N}_{s 2} ) {R}_{2}}{{R}_{1} {R}_{2} + {R}_{2} {R}_{3} + {R}_{3} {R}_{1}} . \qquad ( 54 )$$

It is evident that the leakage flux component

$$\frac{( {I}_{p} {N}_{p 2} + {I}_{s} {N}_{s 2} ) {R}_{2}}{{R}_{1} {R}_{2} + {R}_{2} {R}_{3} + {R}_{3} {R}_{1}}$$

circulates around the outer limbs of the transformer core and contributes to @1 and @3. On the other hand, the magnetizing flux @2 is distributed across all limbs of the E core, originating from the central limb. Consequently, these two fluxes combine in one of the outer limbs and cancel each other in the opposing side limb. As a result, the magnetic core flux density distribution varies among the three limbs of the core, as may be observed in FEA simulation results.

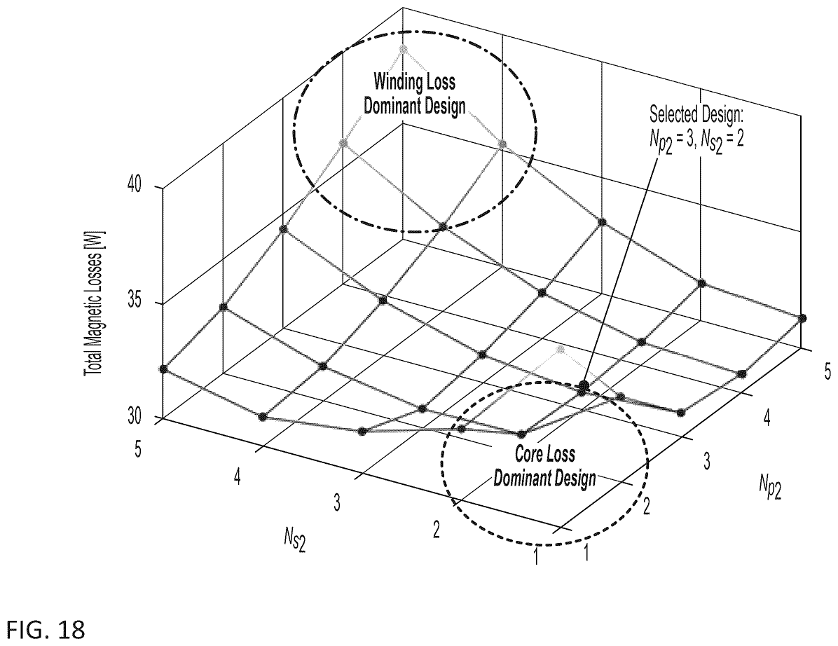

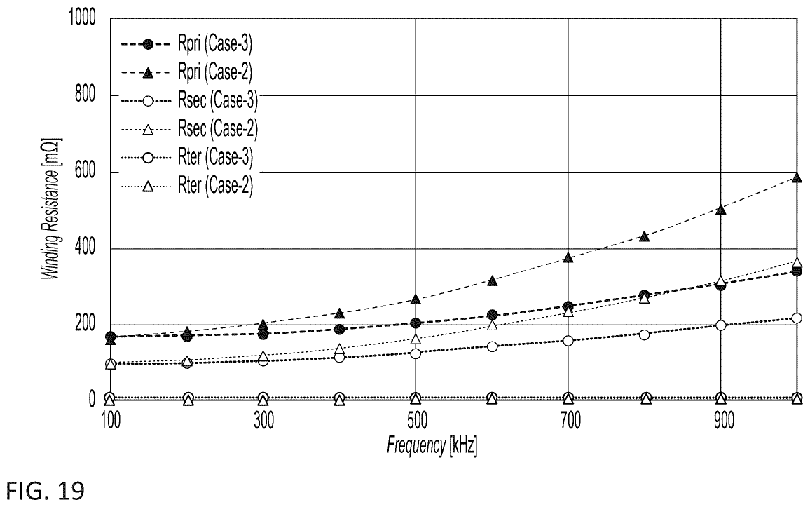

An optimal distribution of the winding turns may then be selected that attains the least total magnetic (i.e., core+winding loss) loss by considering the trade-off discussed above. The magnetic loss-based design optimization result is shown in FIG. 18, where the combined core and winding loss of the transformer is graphically presented for different numbers of Nₚ₂ and Nₛ₂ that achieve the same leakage inductances with the given core geometry and corresponding central and side limb air gaps. Here, the core loss and winding losses are determined by following a technique similar to the one described for the Case 1 and Case 2 designs. While searching for the least total magnetic loss operating point in the plot of FIG. 18 that maintains the current transfer ratio requirement of Equation 52, the Case 3 transformer design may be finalized as: Nₚ₁=12, Nₚ₂=3, Nₛ₁=9, Nₛ₂=2, and Nₜ₌₂. The variation of the winding resistances for the Case 2 and Case 3 designs with the current excitation frequency are presented graphically in FIG. 19. When compared with the Case 1 design, it may be observed that the differential increment in winding resistance with increasing frequency is less for the Case 3 design due to its interleaved winding structure.

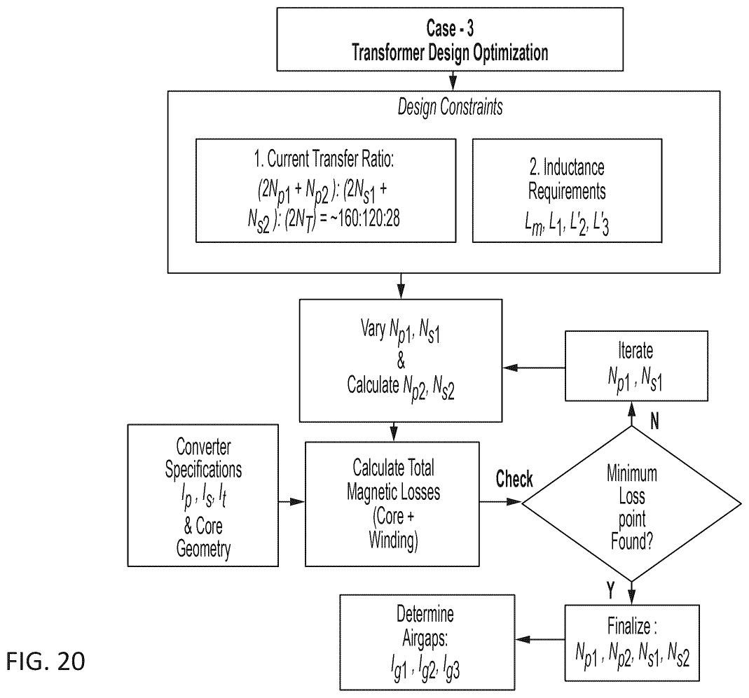

The complete optimization procedure for such a leakage integrated transformer design is presented in the form of a flow chart in FIG. 20. Thus, with such a design, a decoupled control of the magnetizing and leakage inductance may be achieved by varying the central and side limb air gaps separately with far less sensitivity in leakage inductance resulting from air gap variance when compared to the Case 2 design. For the Case 3 design of the three-winding TAB transformer, a magnetizing inductance of 580 μH, and primary and secondary leakage inductances of 15 and 7 μH are realized using core air gap lengths of l_{g1}=l_{g3}=0.1 mm and l_{g2}=0.15 mm.

As used herein, “a portion of” something means “at least some of” the thing, and as such may mean less than all of, or all of, the thing. As such, “a portion of” a thing includes the entire thing as a special case, i.e., the entire thing is an example of a portion of the thing. As used herein, when a second quantity is “within Y” of a first quantity X, it means that the second quantity is at least X-Y and the second quantity is at most X+Y. As used herein, when a second number is “within Y %” of a first number, it means that the second number is at least (1−Y/100) times the first number and the second number is at most (1+Y/100) times the first number. As used herein, the word “or” is inclusive, so that, for example, “A or B” means any one of (i) A, (ii) B, and (iii) A and B.

Methods disclosed herein may be performed by a processing circuit, and control of a power converter (e.g., a TAB converter) may be performed by a processing circuit. Each of the terms “processing circuit” and “means for processing” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

As used herein, when a method (e.g., an adjustment) or a first quantity (e.g., a first variable) is referred to as being “based on” a second quantity (e.g., a second variable) it means that the second quantity is an input to the method or influences the first quantity, e.g., the second quantity may be an input (e.g., the only input, or one of several inputs) to a function that calculates the first quantity, or the first quantity may be equal to the second quantity, or the first quantity may be the same as (e.g., stored at the same location or locations in memory as) the second quantity.

The terminology used herein is for the purpose of describing particular embodiments only and is not intended to be limiting of the inventive concept. As used herein, the terms “substantially,” “about,” and similar terms are used as terms of approximation and not as terms of degree, and are intended to account for the inherent deviations in measured or calculated values that would be recognized by those of ordinary skill in the art.

Any numerical range recited herein is intended to include all sub-ranges of the same numerical precision subsumed within the recited range. For example, a range of “1.0 to 10.0” or “between 1.0 and 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Similarly, a range described as “within 35% of 10” is intended to include all subranges between (and including) the recited minimum value of 6.5 (i.e., (1-35/100) times 10) and the recited maximum value of 13.5 (i.e., (1+35/100) times 10), that is, having a minimum value equal to or greater than 6.5 and a maximum value equal to or less than 13.5, such as, for example, 7.4 to 10.6. Any maximum numerical limitation recited herein is intended to include all lower numerical limitations subsumed therein and any minimum numerical limitation recited in this specification is intended to include all higher numerical limitations subsumed therein.

It will be understood that when an element is referred to as being “directly connected” or “directly coupled” to another element, there are no intervening elements present. As used herein, “generally connected” means connected by an electrical path that may contain arbitrary intervening elements, including intervening elements the presence of which qualitatively changes the behavior of the circuit. As used herein, “connected” means (i) “directly connected” or (ii) connected with intervening elements, the intervening elements being ones (e.g., low-value resistors or inductors, or short sections of transmission line) that do not qualitatively affect the behavior of the circuit.

Although exemplary embodiments of a transformer with leakage inductance have been specifically described and illustrated herein, many modifications and variations will be apparent to those skilled in the art. Accordingly, it is to be understood that a transformer with leakage inductance constructed according to principles of this disclosure may be embodied other than as specifically described herein. The invention is also defined in the following claims, and equivalents thereof.

What is claimed is:

1. A system, comprising:
a transformer comprising:
a core, comprising:
a central limb,
a first outer limb, and
a second outer limb;
a first winding; and
a second winding,
wherein a first turn of the first winding encircles the central limb and the first outer limb.

2. The system of claim 1, wherein a first turn of the second winding encircles the central limb and the second outer limb.

3. The system of claim 2, wherein a second turn of the first winding encircles the central limb and the first outer limb.

4. The system of claim 3, wherein a second turn of the second winding encircles the central limb and the second outer limb.

5. The system of claim 1, wherein the transformer further comprises a third winding.

6. The system of claim 5, wherein a turn of the third winding encircles the central limb.

7. The system of claim 6, wherein every turn of the third winding encircles the central limb.

8. The system of claim 6, wherein a turn of the third winding comprises two conductors connected in parallel.

9. The system of claim 5, wherein the transformer comprises a first printed circuit board, comprising a turn of the second winding.

10. The system of claim 9, wherein:
the transformer comprises a second printed circuit board;
the first printed circuit board comprises a turn of the first winding; and
the second printed circuit board comprises a turn of the first winding.

11. The system of claim 10, wherein the second printed circuit board comprises a turn of the third winding.

12. The system of claim 10, wherein the second printed circuit board is separated from the first printed circuit board by a gap.

13. The system of claim 9, wherein:
a first layer of the first printed circuit board comprises a first turn of the first winding;
a second layer of the first printed circuit board comprises a second turn of the first winding; and
a third layer of the first printed circuit board, between the first layer and the second layer, comprises a turn of the second winding.

14. The system of claim 1, wherein the core is an E-E core.

15. The system of claim 1, wherein the first turn of the first winding comprises copper wire.

16. The system of claim 15, wherein the first turn of the first winding comprises copper Litz wire.

17. A system, comprising:
a transformer comprising:
a core, comprising:
a first outer limb, and
a second outer limb; and
a printed circuit board, comprising:
a first winding,
a second winding, and
a third winding,
wherein:
a first turn of the second winding encircles the first outer limb in a first layer of the printed circuit board,
a second turn of the second winding encircles the first outer limb in the first layer, and
only one turn of the second winding encircles the second outer limb in a second layer of the printed circuit board.

18. The system of claim 17, wherein only one turn of the second winding encircles the first outer limb in a third layer of the printed circuit board.

19. The system of claim 17, wherein the second layer does not include a turn of the second winding encircling the first outer limb.

20. The system of claim 17, wherein the first winding comprises a first number of turns encircling the first outer limb and a second number of turns, different from the first number of turns, encircling the second outer limb.
